(19) United States
(12) Patent Application Publication
(10) Pub. No.: US 2002/0128953 A1
(43) Pub. Date: Sep. 12, 2002

(54) Price discovery and negotiations and related processes

(76) Inventors: Jim Quallen, Pasadena, CA (US); Hans Dau, Malibu, CA (US)

Correspondence Address: BROWN, RAYSMAN, MILLSTEIN, FELDER & STEINER LLP, 900 THIRD AVENUE, NEW YORK, NY, 10022, US

(21) Appl. No.: 09/955,490

(22) Filed: Sep. 17, 2001

Related U.S. Application Data
(60) Provisional application No. 60/233,033, filed on Sep. 15, 2000.
(60) Provisional application No. 60/275,895, filed on Mar. 14, 2001.

(51) Int. Cl. G06F 17/60

(52) U.S. Cl. 705/37

(57) ABSTRACT

The present invention relates to a method and system for standardizing price discovery and negotiation in commercial industries, in a time- and cost-efficient manner.

The present application claims priority from provisional application U.S. Serial No. 60/233,033, filed Sep. 15, 2000 and provisional application U.S. Serial No. 60/275,895, filed Mar. 14, 2001, both of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The present invention is directed to the field of price discovery and negotiation in commercial industries and more specifically to standardizing and streamlining price discovery and negotiation.

Price discovery in many commercial industries is made extremely difficult by the fact that any one job comprises a myriad of different elements to be priced. In order to streamline the price discovery process, many providers developed various heuristics to estimate the price of a job. The heuristics rely on a set of assumptions and generalizations to aid in the price discovery process and thus cannot provide an optimal price for jobs, whose varying specifications and requirements do not uniformly conform to the assumptions and generalizations.

Further, the established practice is focused on bidding on the job as a whole, with the attendant assumptions and generalizations, rather than bidding on the individual elements inherent in any job performed for a specific industry. Thus, a customer determines the specification for a job and then engages a service provider or providers in a “bid-and-buy” process on a job-by-job basis. This is a time-consuming and ineffective practice which requires the customer and the service provider to repeat many redundant steps when bidding on successive specifications.

In the computer age, efforts have been made to streamline business transactional processes. For example, U.S. Pat. No. 4,839,829, discusses an automated printing control system, prior to the advent of the Internet, for transmitting pricing and administrative information. However, the patent merely discusses transmission of information, one job at a time, where the customer specifies all the components of a requested job and asks the printer to provide a price estimate/bid for the job. The patent does not address the problem of streamlining or optimizing price discovery for a requested job or series of jobs and is consistent with the established practice of bidding on the job as a whole, on a job-by-job basis, rather than on the individual elements of the job.

Another example of a prior streamlining effort is 58k.com, a company which launched an auction-based website for the print industry, connecting commercial clients with commercial printers in an interactive auction-type environment over the Internet. (iMarketing News, Nov. 19, 1999). However, the auction-based system implemented by 58k.com only allows price discovery for single print jobs, on a job-by-job basis, is consistent with the established practice of bidding on the job as a whole rather than on the individual elements of the job, and does not provide a system and method for price discovery in connection with a series of recurrent jobs or a series of jobs with differing specifications.

Thus, prior efforts at streamlining the interaction between a customer and a service provider focus on various methods of bidding on the requested job as a whole, on a job-by-job basis. The bidding is on the end product, rather than on the components of the process that accomplish the end-product. The problem with this approach is that it results in sub-optimal price estimates obtained in a time-inefficient manner. The present invention allows customers and service providers economically to collect and process price data across a vast multitude of price factors for each component which may be involved in a job specification in a given industry and to create a price data set which can be applied to an infinite number of jobs without further negotiation or bidding efforts, thereby providing a time-efficient system and method for optimal price discovery in commercial industries.

### SUMMARY OF THE INVENTION

The present invention relates to standardizing price discovery and negotiation in commercial industries. More specifically, the invention relates to a method and system for obtaining, negotiating and standardizing contract prices in a time- and cost-efficient manner.

A method and system of the present invention allows vendors to understand, compare and analyze buyers' Demand Sets at a level of detail far in excess of the present state of the art. The system allows collection of bid data electronically, preferably online, in standardized formats specific to the relevant industry. Once collected, the system automates the analysis of the data to develop a Target Rate List.

According to an embodiment of the present invention, a method of standardizing price discovery and negotiation using a computer processing system comprises receiving at least one demand for a generic bid; associating with said demand at least one vendor bid; and analyzing the at least one vendor bid to identify a preferred bid for each performance element.

According to a further embodiment of the present invention, a method of standardizing price discovery and negotiation using a computer processing system comprises receiving at least one Demand Set comprising a buyer's specifications for performance elements; associating with said Demand Set at least one vendor bid; and analyzing the at least one vendor bid to identify a preferred bid for each performance element.

According to a further embodiment of the present invention, a method of standardizing price discovery and negotiation using a computer processing system comprises receiving at least one demand for a generic bid; associating with said demand a first round of at least one vendor bid; analyzing the first round of at least one vendor bid to identify a first preferred bid; associating with said demand a second round of at least one vendor bid, wherein said second round of at least one vendor bid is a percentage of the first preferred bid; and identifying a second preferred bid.

According to a further embodiment of the present invention, a method of standardizing price discovery and negotiation using a computer processing system comprises receiving at least one Demand Set comprising a buyer's specifications for performance elements; associating with said Demand Set a first round of at least one vendor bid; analyzing the first round of at least one vendor bid to identify a first preferred bid for each performance element; associating with said Demand Set a second round of at least one vendor bid for at least one performance element, wherein said second round of at least one vendor bid is a percentage of the first preferred bid for at least one performance element; identifying at least one second preferred bid for each performance element; and compiling a schedule of second preferred bids for each performance element.

According to a further embodiment of the present invention, a system for standardizing price discovery and negotiation comprises a receiving device for receiving at least one Demand Set comprising a buyer's specifications for performance elements; an associating means for associating with said Demand Set at least one vendor bid; and a processor for analyzing the at least one vendor bid to identify an preferred bid for each performance element.

According to a further embodiment of the present invention, a system for standardizing price discovery and negotiation comprises a receiving device for receiving at least one Demand Set comprising a buyer's specifications for performance elements; a means for associating with said Demand Set a first round of at least one vendor bid; a processor for analyzing the first round of at least one vendor bid to identify a first preferred bid for each performance element; a means for associating with said Demand Set a second round of at least one vendor bid for at least one performance element, wherein said second round of at least one vendor bid is a percentage of the first preferred bid for at least one performance element; a processor for identifying at least a second preferred bid for each performance element; and a processor for compiling a schedule of the second preferred bids for each performance element.

According to a further embodiment of the present invention, the method and system allows a buyer economically to solicit multiple rounds of bids from a vast vendor set, drastically reducing bilateral negotiations.

According to a further embodiment of the invention, the results of the negotiations are instantiated in an electronic PRIVATE RATECARD calculator that permits a negotiated outcome customized to each vendor in industries with complex pricing structures. This is referred to herein as PRIVATE RATECARD contracting.

According to a further embodiment of the invention, a buyer can supplement PRIVATE RATECARD contracting with spot bidding and/or auction processes.

According to a further embodiment of the invention, a third party may publish a Public Pricing Index against which other buyers and vendors can refer to express their prices.

According to a further embodiment, vendors can publish prices expressed in reference to a Public Pricing Index, thereby creating a PUBLIC RATECARD.

According to a further embodiment, the system allows buyers to utilize look-up engines and search engines to compare PUBLIC RATECARD prices.

According to a further embodiment, a buyer can use a PUBLIC RATECARD calculator to discover which vendors provide superior pricing for the buyer's specifications at a given moment in time.

According to a further embodiment, a buyer also may compare the outcome from a PUBLIC RATECARD calculator with outcomes from a PRIVATE RATECARD calculator in order to ascertain the most favorable pricing available to that buyer in the market. Generally, a buyer generates a Demand Set for performance by a vendor or vendors in a particular industry, such as the printing industry, the shipping industry or any other commercial industry in which a buyer needs to procure goods or services. The Demand Set contains the various elements of performance likely to be required in a given industry, such as specifications and service level requirements. A buyer supplies the raw data comprising the Demand Set by providing the specifications, for any or all of the elements, which the buyer has required in the past and/or expects to require in the future.

The Demand Set is made available at a buyer's option, either to all vendors within an industry or only to those vendors authorized by the buyer to receive the Demand Set. Preferably, the Demand Set is made available online to all authorized vendors or made available in any other fashion that is accepted in the relevant industry or preferred by the parties.

As a vendor receives Demand Sets from buyers, the vendor can analyze them to determine the attractiveness of each buyer's Demand Set given the vendor's equipment and capabilities. Preferably, the comparison is conducted by means of a look-up engine or a query engine which would allow a vendor to find, compare and analyze portions of the Demand Set by criteria of interest to the vendor.

A vendor can submit a bid to any received Demand Set. According to a system of the present invention all vendor bids for a particular Demand Set are collected and analyzed. Preferably, the collection and analysis are performed online. The analysis is performed by use of an algorithm that is customizable by the buyer. The output of the analysis is a Target Rate List containing a price for each bid element.

The Target Rate List is visible only to the participating vendors by means of, for example, being posted online on a website designed for this purpose. The Target Rate List is utilized as a reference point for all subsequent negotiations between the parties for performances in the relevant industry.

Once a Target Rate List is generated and vendors have signaled their willingness to perform for the buyer at the prices indicated on the Target Price List, a buyer can stop the bidding process. A buyer also could invite a second round of bids, where the bids are expressed as a percentage of the Target Rate List.

Either the first or the second or subsequent rounds of bidding may lead to a contract for a particular performance or to an agreement to agree on later performances. An agreement to agree takes the form of a PRIVATE RATECARD, which may be expressed as a set of percentages of the corresponding Target Price List or a set of actual dollar figures. A PRIVATE RATECARD is an electronic or paper schedule, presented in any acceptable format and containing the set of agreed upon prices for various performance elements. A PRIVATE RATECARD also contains a formula which, with the aid of a PRIVATE RATECARD calculator in accordance with this invention, is used to translate the schedule of agreed upon prices into a total price for a future specification. FIG. 2 illustrates one embodiment according to the present invention to create a PRIVATE RATECARD.

A PRIVATE RATECARD is used by a buyer to enter into a contract with a vendor. A buyer can draft the specification for a given job, preferably by using pre-prepared templates from a central database; use the PRIVATE RATECARD calculator to determine the total job price; and, based on the calculations and the particular job specification, select one of the vendors whose bid is included in the PRIVATE RATECARD.

Optionally, a buyer can supplement the selection process with spot bidding and/or auction processes. Spot bidding occurs when a vendor bids for a given job specification, wherein the bid represents a one-job discount from the schedule of prices which would otherwise control the calculation of the job price as computed by the PRIVATE RATECARD calculator. Spot bidding can be used to take advantage of job specifications the price for which may fluctuate depending on the season, the equipment available to a vendor at a given time, or for any other reason. An auction process can be used alone or in conjunction with the spot bidding process in order to help price unique elements of the specification which are difficult or not possible to accurately price with the PRIVATE RATECARD calculator.

A PRIVATE RATECARD calculator also can be used to re-price any number of change orders and to display the results to both buyer and vendor. Also, a PRIVATE RATECARD calculator can be adjusted to reflect new pricing information from external sources, such as, for example, a third party pricing index upon which one or more pricing elements may be dependent.

According to an alternative embodiment of the invention, any individual, entity or organization may publish a Public Pricing Index, containing a schedule of target prices, based on the price collection and target rate determination processes according to this invention. Once the Public Pricing Index is published, many but not all buyers, particularly small and midsize companies, will find that they do not need to conduct price determination and target rate processes. The Public Pricing Index may be adjusted over time for both macroeconomic factors, such as inflation, and microeconomic factors particular to the industry, such as a rapid rate of technological advance. A vendor may publish a public asking price, as described herein, expressed as a percentage of the Public Pricing Index. The resulting schedule is referred to herein as a PUBLIC RATECARD. The vendor may then make the PUBLIC RATECARD available to buyers in the vendor's industry, either by posting the PUBLIC RATECARD online or by any other means. A buyer may contract with a vendor with the most favorable PUBLIC RATECARD or, alternatively, a buyer may review the available PUBLIC RATECARDS, preferably by means of a look-up engine or a search engine that would enable the buyers to search and compare the PUBLIC RATECARDS by job-elements of interest. Optionally, a buyer may use a PUBLIC RATECARD calculator to determine the total price for a given job using the pricing schedule in any given PUBLIC RATECARD. Optionally, a buyer then may compare this output with output obtained by using a PRIVATE RATECARD calculator used in connection with any of the buyer's PRIVATE RATECARDS.

Embodiments of the present invention are further described hereinbelow.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a schematic representation of one embodiment of the invention;

FIG. 2 is a flow chart illustrating use of an embodiment of the present invention to perform price collection;

FIG. 3 is a flow chart illustrating use of an embodiment of the present invention to select a pricing basis;

FIG. 4 is an illustration of target rate determination;

FIG. 5 is a flow chart illustrating the use of an embodiment of the present invention to create a PRIVATE RATECARD;

FIG. 6A is a flow chart illustrating the use of an embodiment of the present invention to enter into contracts using a PRIVATE RATECARD;

FIG. 6B is a flowchart illustrating use of another embodiment of the present invention to enter into contracts using a PRIVATE RATECARD;

FIG. 6C is a flowchart illustrating use of another embodiment of the present invention to enter into contracts using a PRIVATE RATECARD;

FIG. 6D is a flowchart illustrating use of another embodiment of the present invention to enter into contracts using a PRIVATE RATECARD;

FIG. 7 is a flowchart illustrating use of an embodiment of the present invention to update PRIVATE RATECARD pricing;

FIG. 8 is a flowchart illustrating use of an embodiment of the present invention to create a job specification template;

FIG. 9 is a flowchart illustrating use of an embodiment of the present invention to reprice a change order using a PRIVATE RATECARD;

FIG. 10 is a flowchart illustrating the use of an embodiment of the present invention allowing an independent party to publish a Public Pricing Index;

FIG. 11A is a flow chart illustrating the an alternative embodiment of the present invention comprising using a PUBLIC RATECARD;

FIG. 11B is a flow chart illustrating the an alternative embodiment of the present invention comprising using a PUBLIC RATECARD;

FIG. 12 is an illustration of calculations performed by a PRIVATE RATECARD calculator.

FIG. 13A is an illustration of a web page of one embodiment of a job specification template according to the present invention.

FIG. 13B is an illustration of a web page of one embodiment of a job specification template according to the present invention

FIG. 13C is an illustration of a web page of one embodiment of a job specification template according to the present invention

FIG. 13D is an illustration of a web page of one embodiment of a job specification template according to the present invention

### DETAILED DESCRIPTION OF THE PREFERRED EMBODIMENTS

The present invention may be implemented by any computer processing system, such as, for example, the Internet, any wide area, local or virtual networks or a CD ROM. Although it is theoretically possible to carry out the principles and methods of the present invention manually, the overwhelming amount and complexity of the data that is usually involved in the price discovery and standardization processes of this invention, coupled with realistic time constrains, best lend themselves to computerized manipulation.

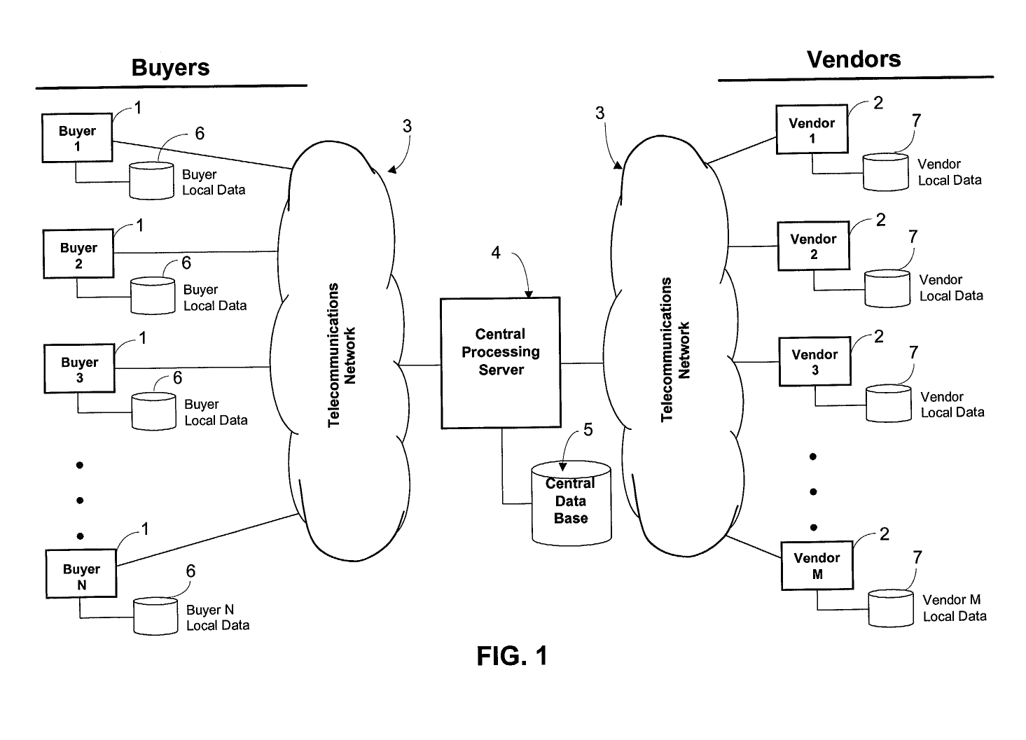

Referring to FIG. 1, the system of the present invention preferably is conducted online, for example by means of a website which is accessed by buyer(s) 1 and vendor(s) 2 through a telecommunications network 3. Each buyer 1 can have access to a local database 6 for storing data related to the buyer's business generally or to a particular transaction. Each vendor 2 can have access to a database 7 related to the vendor's business generally or to a particular transaction. One or more buyers 1 can communicate with one or more vendors 2 through a telecommunications network 3 linked to a central processing server 4 and associated central database 5. Preferably, the system services the commercial printing industry, although it will be obvious to one skilled in the art to adopt the system to other industries, such as, for example, the industries and applications shown in Table 1, which is attached at the end of the specification.

Minimize Risk Premia in the Buyer's Demand Set

Traditionally, vendor estimation algorithms included implicit and explicit attempts to price-in unknown elements of the buyer's Demand Set (described below). Allowing authorized vendors automated access to a buyer's Demand Set minimizes the number of unknown elements previously hidden within the Demand Set, thereby reducing the number of assumptions required of the vendor and the corresponding risk premia incorporated by the vendor into bid prices. The end result is lower prices to commercial print buyers.

A buyer posts a Demand Set for commercial print work on a central database associated with the website. A Demand Set contains a buyer's specifications for performance elements, such as, for example, print job requests and related specifications for those jobs. In the print industry, such requests and related specification include, for example, quantity, attributes of the product to be produced (such as, for example, finished product dimensions, number of pages, number of colors, grade and finish of paper, type of binding, type of packing), service level requirements (such as, for example, the length of the manufacturing window which the buyer affords the vendor to manufacture the product) and quality requirements. A Demand Set need not be restricted to containing historical information, it could also contain the buyer's best estimate of future needs as well. The posted Demand Set is accessible to an authorized list of vendors, selected by the buyer. To aid a buyer, the system includes an inventory of vendors; however, a buyer may select vendors that are not included in the system's inventory. Various security procedures that are known in the art, such as, for example, user identification passwords or party enablement in trading systems, can be used to limit access to the buyer's information to the authorized vendor list. It is also possible to allow a buyer the option to include the Demand Set in a separate freely searchable public database available to all vendors to, for example, allow a vendor to find buyers with Demand Sets that are most suitable to that vendor's equipment and capabilities.

The Demand Set information is presented in an interactive, searchable format, preferably in a drill down form, although other interactive formats and search engines, and on-line analytical processing techniques known in the art may be used. The Demand Set information may be searched using multiple queries on one or more attributes of the data contained therein. For example, an interactive drill down format may be structured by allowing a vendor to search by various categories, such as by searching for buyers who routinely request long runs with a high number of colors and a saddle stitched binding. The search results can be displayed in summary format, which is customizable by the vendor. Previous attempts to solve the embedded risk premia problem in commercial print pricing have produced limited results. A buyer generally furnishes a manual written summary describing the Demand Set to the vendor population. Due to time constraints, this manual written summary would not quantitatively delineate, on either a historical or a prospective basis, the relative dollar and production volume distribution of work performed by the buyer across the principal commercial print manufacturing technologies (for example, sheetfed, halfweb, and fullweb), color requirements (for example, preparation of work below 3 colors, 4-6 colors, and 6 colors), and finishing requirements. The vendor would be left to guess these parameters.

Price Collection

Each vendor that is interested in a buyer's Demand Set submits a bid. Preferably a buyer collects bids after publishing a Demand Set; however, a buyer may omit this step and collect generic bids without this information. Example 1 shows one embodiment of the price collection process according to this invention as applied to the commercial print industry.

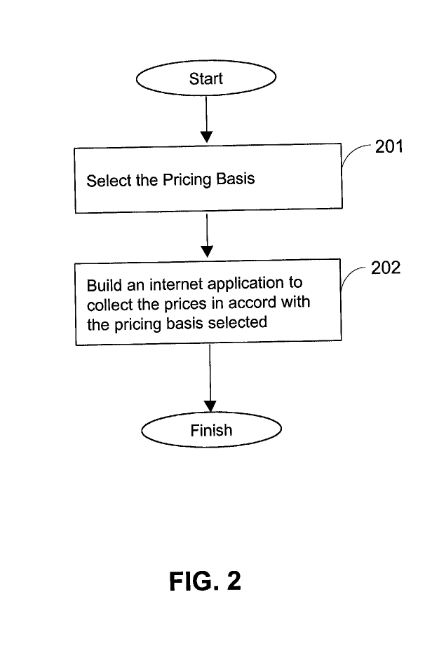

Referring to FIG. 2, price collection involves selecting the pricing basis, step 201, and building an Internet or other computerized application to collect the prices in accord with the pricing basis selected, step 202.

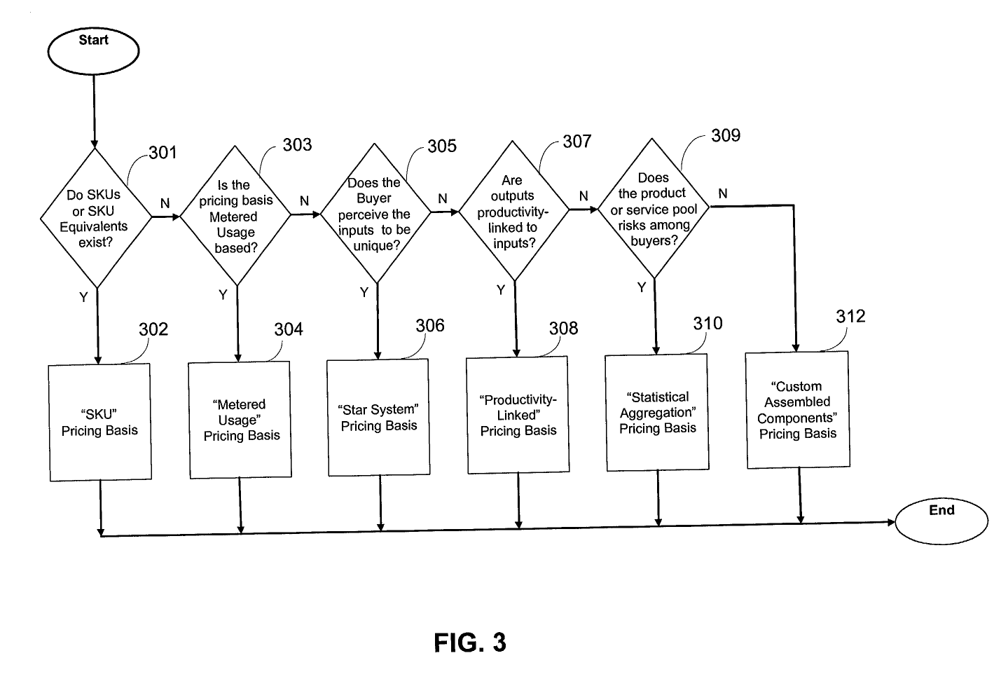

Selecting a pricing basis for each category in a given industry requires identifying the nature of the product or service that is being priced. Referring to FIG. 3, the first question, in step 301, in making this determination is whether Stock-Keeping-Units (“SKUs”) or SKU Equivalents exist within the category. The pricing basis of the product or service is said to be SKU Based when there exists an identifiable SKU or “SKU Equivalent” (as described below) with known or ascertainable specifications which completely describe the product or service. A SKU is most readily identifiable on a product when the seller affixes the SKU designation to the product itself, or otherwise assigns and makes publicly available a unique SKU designation for a distinct product or service (a “SKU Number”). There must always be a 1-to-1 relationship between a SKU Number or a SKU Equivalent and the specifications which uniquely define the product or service. SKU Equivalents are numeric or alphanumeric descriptors that are functionally equivalent to a SKU Number, but are called by a different name by trade or custom. For example, the electronics industry commonly uses a model number to uniquely identify the products available for sale by a given manufacturer; therefore, model numbers in the electronics industry are SKU Equivalents. Although, SKU Numbers and SKU Equivalents are most commonly used in a product context to refer to a finished output of any stage of a manufacturing or delivery process, it is not uncommon to see SKU Equivalents in the service sector. A prominent example of a SKU Equivalent in the service sector is the American Medical Association's Current Procedure Terminology (CPT®) procedure coding system. CPT is a widely accepted listing of descriptive terms and identifying codes for reporting medical services under public and private health insurance programs. A physician using the CPT procedure coding system itemizes the procedures performed and the resulting charges generated for a given patient by identifying the CPT code for each procedure performed on the patient invoice. Because there is a 1-to-1 relationship between CPT codes and procedures, the health plan administrator can readily identify each procedure and apply complex benefit formulas based on those procedures to process claims.

If SKU or SKU equivalents exist or can be readily created, then, as shown in step 302 of FIG. 3, the pricing basis of the product or service is SKU based.

If no SKU Number or SKU Equivalent exists for the product or service, then the pricing basis of the product or service is not SKU-Based. In this case, as shown in FIG. 3, step 303, the second question is whether the pricing basis of the product or service is Metered Usage Based. If so, then, as shown in step 304, the Metered Usage pricing basis applies. In a Metered Usage Based product or service, the buyer has great difficulty specifying prior to purchase, the exact quantity of the good or service to be consumed. As a result, the buyer and seller agree in advance of the purchase to a pricing basis based on the rate of consumption of the good or service (dollar amount per unit consumed) during a specified amount of time. Importantly, the total invoice amount for a given period can only be known in retrospect after the consumption occurs. Generally, the buyer and seller make special provisions for monitoring the amount of consumption that occurs over time, and often there is a formalized consumption measuring device or other informal arrangement to serve the same purpose. For example, utilities and utility-like products and services are often Metered Usage services, with electricity, water, and natural gas most frequently priced on a Metered Usage basis. However, many professional services are also Metered Usage based services. Lawyers, for example, often bill clients for legal services rendered at an hourly billing rate, often without an explicit cap on fees to be incurred for a given project.

If the pricing basis for a given product or service is neither SKU nor Metered Usage, then referring FIG. 3, step 305, the third question is whether the buyer perceives the nature of the product or service to be unique. If so, then, as shown in step 306, the Star System pricing basis applies. Under the Star System pricing basis, the price for the service is de-coupled from any explicit or implicit productivity metrics which would tie any given level of input to the output. For example, the fee a sports celebrity may be able to command from an advertiser for making available his or her image or likeness in the promotion of a product or service may have no relation whatsoever to the level of time or effort expended by the celebrity in endorsing the product. A tennis celebrity may need only to sign a contract a supply a signature for reproduction onto mass produced tennis racquet in order to generate an endorsement fee from an athletic equipment manufacturer. For these categories, the pricing basis is dollars per transaction, where the transaction is often an endorsement.

If the pricing basis for a given product or service is not SKU, nor Metered Usage, nor Star System, then referring to FIG. 3, step 307, the fourth question is whether outputs productivity are linked to inputs, which requires determining whether factor inputs are linked to outputs via explicit or implicit productivity metrics. If such productivity metrics exist, then, as shown in step 308, the pricing basis for the category is Productivity-Linked. The Productivity Linked pricing basis occurs frequently when labor is a large factor input in a category and the bidder has replicated the tasks to be performed often enough to create a high degree of predictability as to the ultimate amount of labor required to complete the job. For example, a Productivity Linked pricing basis can be found in base building cleaning where contracts are typically priced as a periodic fixed dollar amounts in exchange for a very well-defined level of cleaning services on a scheduled basis over an extended period of time. Increases or decreases in the cleaning service level translate directly into higher or lower costs. Some types of professional services such as audits performed by public accounting firms typically have a Productivity Linked pricing basis as well. Productivity-Linked categories have a dual pricing basis: bids should be organized around both the final job price and the (implicit or explicit) assumption regarding the productivity of the staff assigned to the work consistent with the final job price.

If the pricing basis for a given product or service is not SKU, nor Metered Usage, nor Star System, nor Productivity-Linked, then referring to FIG. 3, step 309, the fifth question is whether the product or service pools risks among buyers. If so, then, as shown in step 310, the pricing basis is Statistical Aggregation based. The Statistical Aggregation pricing basis exists when products or services are assembled from components that are priced based on the statistical properties of risk pools. For example, most insurance products and insurance-like products such as maintenance warranty services have a Statistical Aggregation pricing basis, because the bidder must calculate a claim or service incidence across a group, or pool, of covered risks. Statistical Aggregation categories have a dual pricing basis: bids should be organized around both the price for accepting the risk for the entire pool for a given period of time (this figure is called the premium in insurance categories) as well as the implied incidence of a covered events during the term covered by the bid. Implicitly, these two figures allow the computation of the per-event price underlying the premium. For example, in personal computer maintenance warranty contracts, the pricing basis for a well constructed bid should include both the aggregate cost of maintenance coverage for the term and the expected number of covered repair events during the term.

Finally, if the pricing basis for a given product or service is not SKU, nor Metered Usage, nor Star System, nor Productivity-Linked, nor Statistical Aggregation, then referring to FIG. 3, step 312, the pricing basis is Custom Assembled Components. In Custom Assembled Components categories, the price of the finished good or service is built up, or assembled, from the price of the underlying manufacturing processes or components required to make the good or service. Often, there is no consistency in specifications across finished goods or completed services rendered by companies in custom assembled components industries. That is, every job that they perform may indeed be different from every other job that they perform. In these types of Custom Assembled Components industries, the pricing basis is the components themselves. In process based manufacturing industries, the components are the processes. For example, in general commercial printing, the pricing basis is the set of discrete job steps required to manufacture commercial printed matter, rather than the finished specification for the matter.

Creating a Target Rate List

In the traditional commercial print environment, incumbent vendors who glean the outlines of a buyer's Demand Set by virtue of their incumbency gain a considerable pricing advantage over non-incumbent vendors. An intent of the present invention is to level the playing filed between incumbent and non-incumbent vendors in an economical fashion. In an embodiment of the invention it would be possible for a buyer to link its purchasing transaction processing system so as to continuously update the Demand Set visible to its authorized vendors.

Once all the bids are collected, a system of the present invention uses an algorithm to analyze all of the data collected for each bid element and to identify a preferred bid for each element. As referred to herein, a preferred bid is any bid which is preferred by the buyer based on any one or more criteria. Any number of algorithms known in the art may be used to determine a preferred bid. For example, the data may be organized in rank order, lowest to highest for each element of the bids. The selection parameter of the algorithm is customizable. For example, a buyer may specify an output where, given “m” vendors and m>“n”, the nth lowest bid is chosen as the preferred bid for each bid element. An alternate algorithm may be to use the mean or median bid as the preferred bid. The output is a Target Rate List, setting forth one target price for each bid element. Preferably, the Target Rate List is subsequently adjusted to achieve internal consistency of the prices, either by blunt ocular analysis or by computerized means.

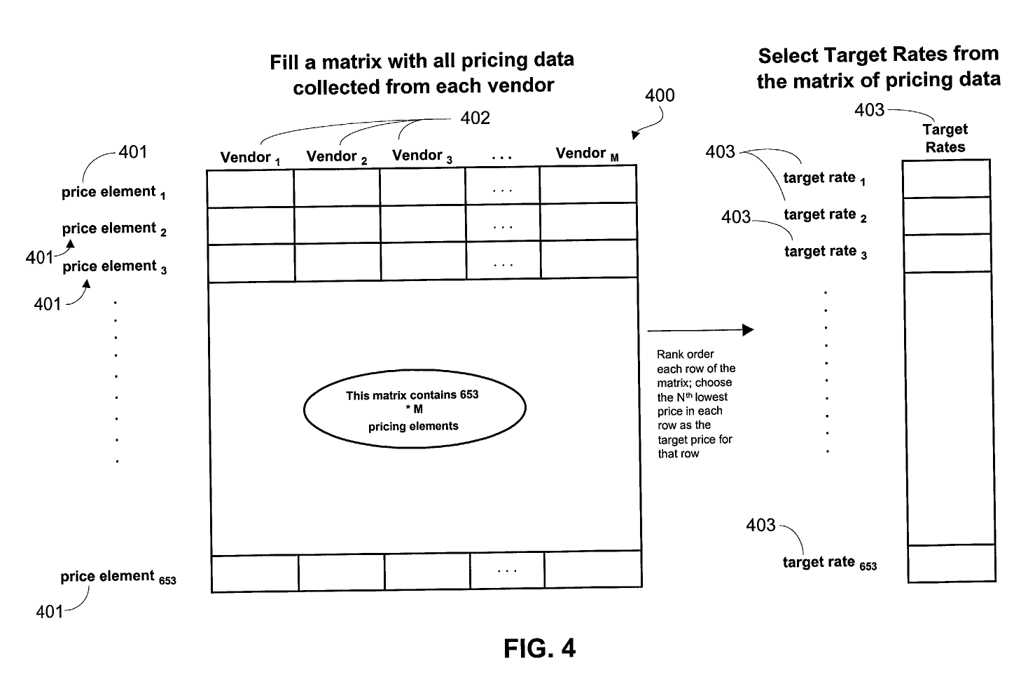

FIG. 4 shows one example of a target rate determination, using the nth lowest bid price algorithm. The figure shows a matrix 400 comprising 653 different price elements 401 collected from each participating vendor 402. The target rate 403 for each price element 401 in each horizontal row of the matrix 400 is then determined by ranking the prices collected from the vendors 402 in connection with each price element 401 and then choosing the nth lowest price for each price element 401.

The Target Rate List is visible to all vendors, such as, for example, by means of being posted on the website. The present invention utilizes the Target Rate List as a reference point for subsequent negotiations, thereby avoiding time consuming and cumbersome bilateral negotiations customarily engaged in by industry participants.

Preferably, a buyer invites a second round of bids at this juncture, although the second round of bids is optional. Conventionally, second round bids would result in bilateral negotiations over each element of the Target Rate List. However, according to the present invention, a buyer solicits second round bids expressed as a percentage of the Target Rate List. For example, a vendor may submit a second bid at 5% above the entire Target Rate List. Thus, according to the present invention a buyer can simultaneously negotiate with a vast set of vendors in a timely and cost-efficient manner to obtain optimal prices.

The bid price for each element of the printing process may be expressed as a different percentage of the corresponding element in the Target Rate List. Also, it is possible to subdivide the hundreds of individual pricing elements involved in the printing process into a small number of buckets. A bucket, as referred to herein, is a collection of individual public pricing elements, as defined by industry custom or agreed upon by the parties. Examples of buckets may include paper, pre-press, die-manufacturing, press, post-press/off-line finishing and packing, shipping and warehousing. The bid price for each bucket may be expressed as a different percentage of the corresponding bucket in the Target Rate List. For example, the bid price for the pre-press bucket may be expressed as 5% over the corresponding bucket in the Target Rate List whereas the public asking price for off-line finishing bucket may be expressed as 4% under the corresponding bucket in the Target Rate List.

PRIVATE RATECARD Contracting

The secondary round of bids may lead to a contract for all or some of the bid elements of buckets or an agreement to agree as to how pricing will be determined for future work conducted by a vendor or vendors on behalf of the buyer over a finite period. Such contracts or agreements can be incorporated into a conventional commercial contract if the parties desire.

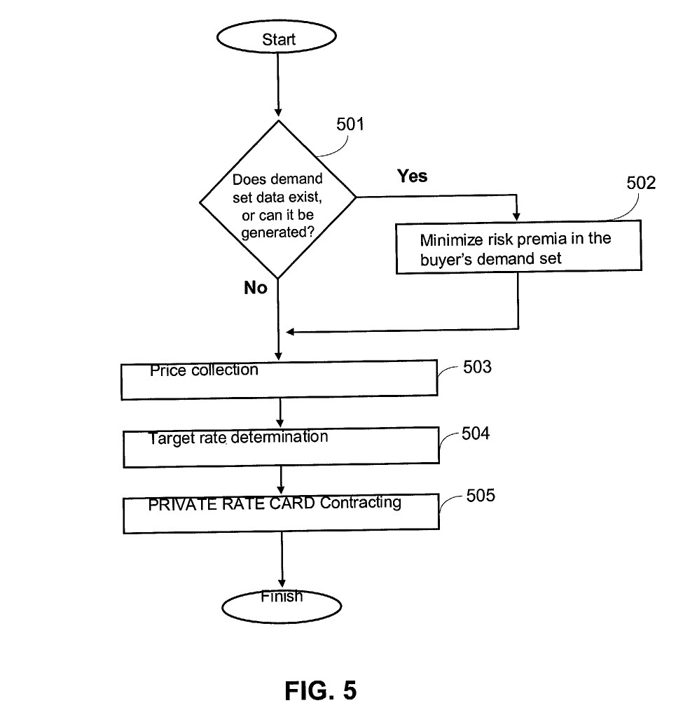

An agreement to agree takes the form of a schedule referred to herein as a PRIVATE RATECARD, which may be expressed as a percentage of the corresponding Target Rate List or an actual dollar figure. FIG. 5 shows how a PRIVATE RATECARD can be created according to an embodiment of this invention. Step 501 asks whether a buyer's Demand Set data exists or whether it can be generated. If so, then step 502 minimizes the risk premia in the buyer's demand set by allowing a vendor to find buyers with Demand Sets that are most suitable to that vendor's equipment and capabilities. If Demand Set data for a buyer does not exist and cannot be generated, then the buyer can supply general specification requirements which are not as detailed as data in a Demand Set would be. Subsequent to step 502, or if Demand Set data does not exist and cannot be generated, the process moves to step 503, price collection, then to step 504, target rate determination, and then to step 505, PRIVATE RATECARD contracting, as discussed below.

A buyer may have one PRIVATE RATECARD for all vendors or a separate PRIVATE RATECARD for each vendor or group of vendors, as the buyer desires. Preferably, a PRIVATE RATECARD is maintained by the parties in confidence, although it may be publicly released if the parties agree.

A PRIVATE RATECARD is an electronic or paper schedule that contains (1) a set of prices agreed upon between the buyer and the vendor at the conclusion of the negotiations and (2) a formula used to translate a specification for a future job into a total job price using the agreed upon set of prices. The formula is usually a linear combination of the pricing elements on the PRIVATE RATECARD. Usually, less than 10% of the bidding elements on the PRIVATE RATECARD are involved in any one job. Preferably, each PRIVATE RATECARD has an expiration date mutually agreed upon by the buyer and the vendor(s).

According to this invention, a standard PRIVATE RATECARD structure allows an independent third party to perform a pricing comparison, evaluation and ranking between pools of buyers, pools of vendors, or both.

PRIVATE RATECARD Calculator

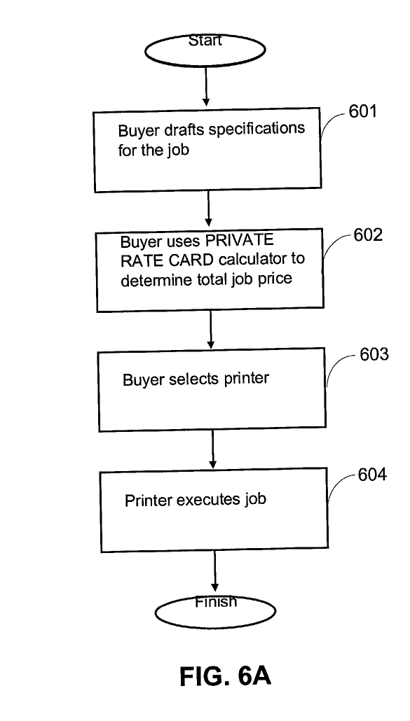

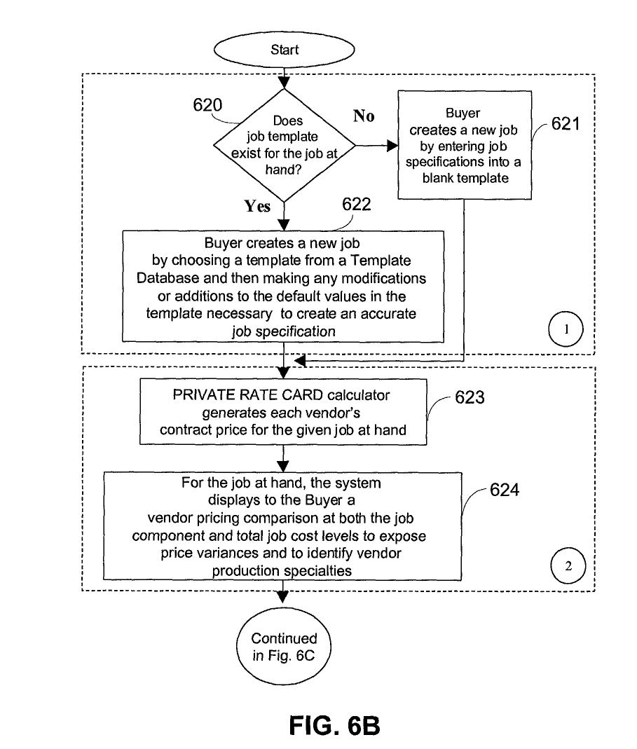

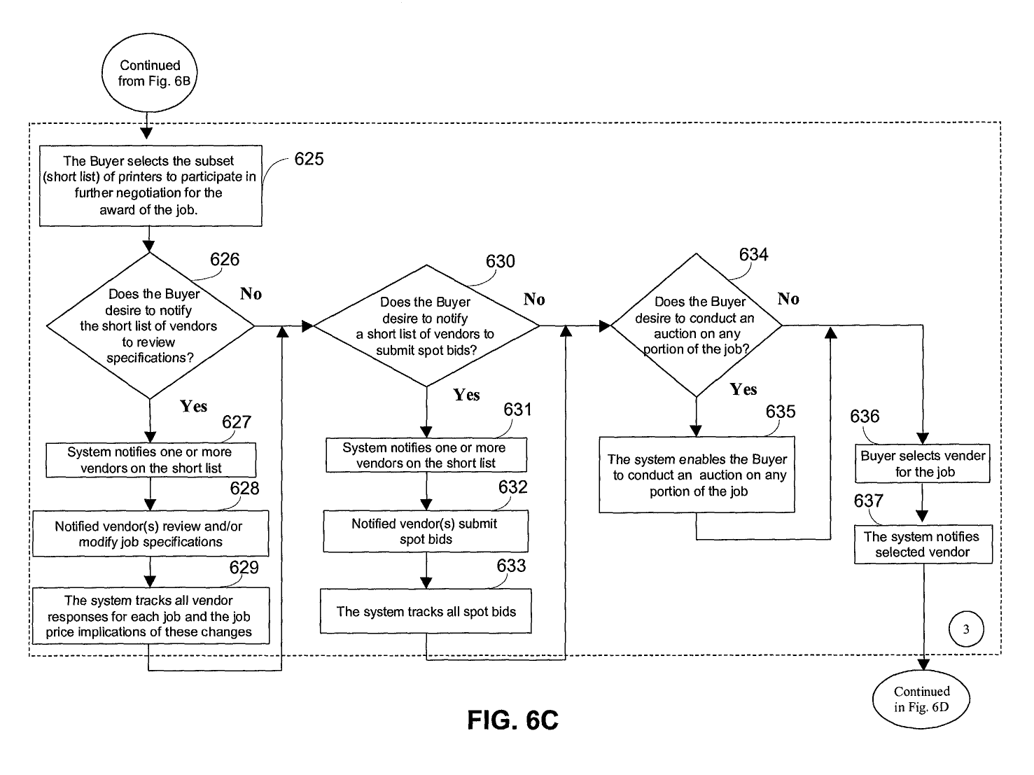

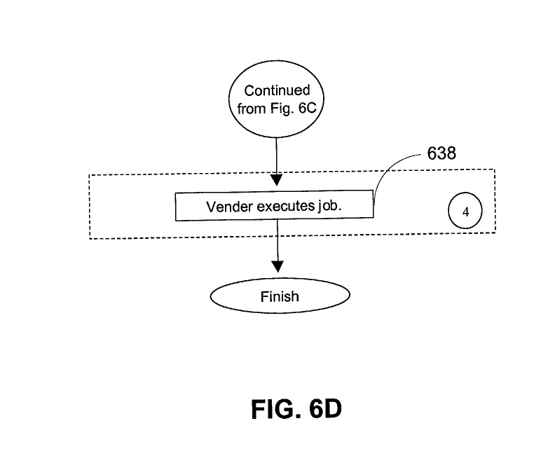

FIG. 6A illustrates an embodiment of how a PRIVATE RATECARD in the commercial printing industry may be used to enter into a contract between a buyer and a vendor, although modifications to this process will be obvious to one skilled in the art. In step 601, when a buyer with a PRIVATE RATECARD needs a print job, the buyer drafts the specifications for the job (which can include any or all of the pricing elements in the PRIVATE RATECARD, depending on the job). The buyer then uses a PRIVATE RATECARD calculator to derive the total price for that job, step 602. The buyer then selects a printer, step 603 and the printer executes the buyer's job, step 604.

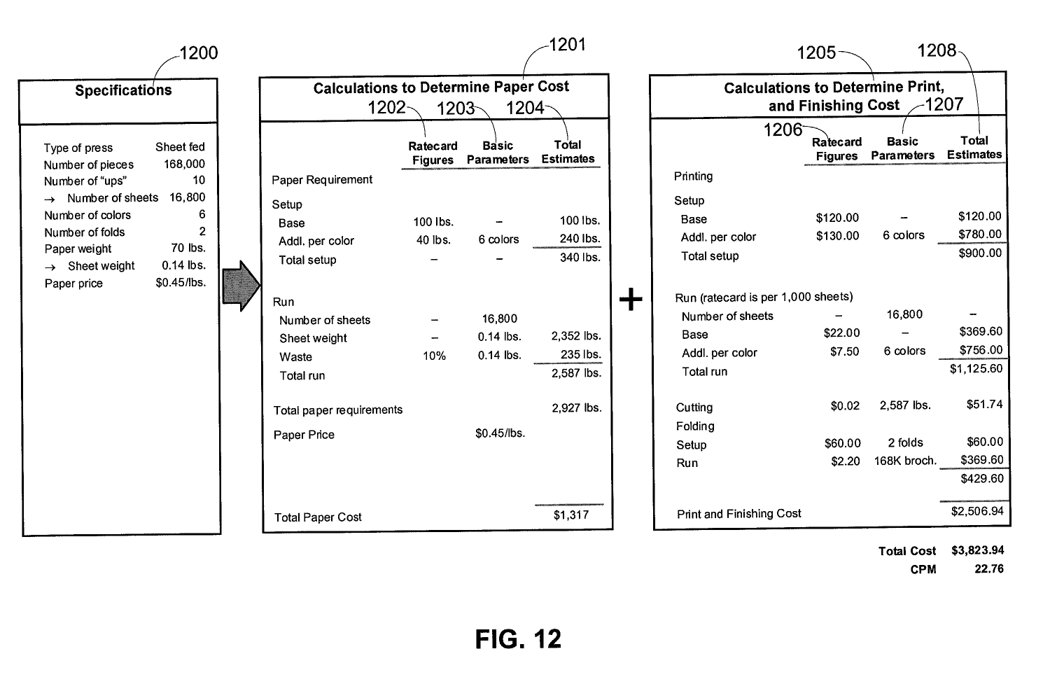

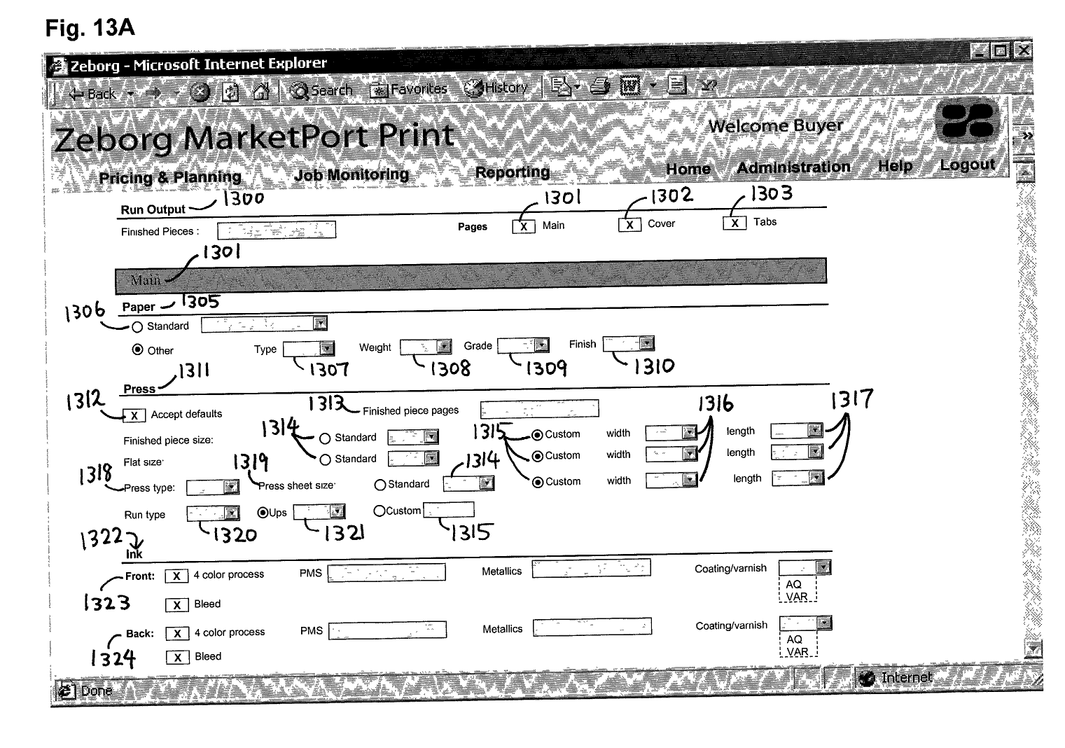

The PRIVATE RATECARD calculator derivation can be obtained by any means known in the art, one of which is illustrated in FIG. 12. FIG. 12 shows an example of how a calculator derivation of the total job price in the printing industry can be obtained for a job request for a monarch size, 3 panel, 6 color brochure. First, the relevant specifications 1200 are selected. Then, calculations to determine paper cost 1201 are performed, since paper cost is usually calculated separately in the printing industry. Paper cost calculations 1201 comprise of determining ratecard FIGS. 1202 from the buyer's PRIVATE RATECARD, such as the price per color and/or per pound of paper; the basic parameters 1203, such as the number of colors and pounds of paper required; and the total estimates 1204 for the paper cost calculations 1201 for the job. Then, print and finishing cost calculations 1205 are performed. These calculations also comprise ratecard FIGS. 1206, for the various elements of the print and finishing costs from the buyer's PRIVATE RATECARD; basic parameters 1207 for these elements; and the total estimate 1208 for the print and finishing cost calculations 1205 for the job. The paper cost calculations 1201 and the print and finishing cost calculations 1205 are then added together to obtain the total price for the job.

Preferably, the PRIVATE RATECARD calculator is an online calculator that includes a look-up engine for locating the relevant bid elements or buckets. The PRIVATE RATECARD calculator implements the PRIVATE RATECARD formula for the agreed upon prices for the relevant bidding elements or buckets and outputs a final price calculation. The format of the output is customizable by the user.

Preferably, the PRIVATE RATECARD calculator is implemented over the Internet to facilitate updates of the calculator to reflect changes in macroeconomic and microeconomic factors, to accommodate new advances in the relevant technology and to reflect changes to the PRIVATE RATECARD schedule of prices. Such implementation also would allow linking an online PRIVATE RATECARD calculator to any of a number of commercial print workflow systems known in the art to achieve efficient pricing and workflow for print procurement work.

The PRIVATE RATECARD calculator can derive prices for multiple PRIVATE RATECARDS. Due to the amount and complexity of the data involved, this task would be immensely burdensome and virtually unmanageable if one were to attempt it manually.

Once the price is calculated, the buyer contacts any of the vendors that had previously agreed to the PRIVATE RATECARD schedule to perform the job. As a result of having a PRIVATE RATECARD calculator, preferably online, a buyer or any employee in a buyer's organization can apply the latest contract terms correctly, ensuring that the negotiated contract rates are actually used in every transaction.

Alternative Embodiment of PRIVATE RATECARD Contracting

A buyer may facilitate completion of the specification drafting step by the use of templates. For example, a buyer may create a new job specification either by entering job requirements into an empty (or “blank”) structured data entry template designed for this purpose, or by utilizing pre-populated templates. As was described above, job specification data can include, for example, such job attributes as quantity, finished size, paper type, numbers of colors, pre-press, and finishing requirements. In some cases, the buyer may have process specifications for a job as well, such as, for example, requirements for specific press type(s) and/or paper sheet size(s). Process specifications are important if the buyer has, for example, pre-purchased a custom paper inventory of a given sheet size that he desires to use for the job at hand.

FIGS. 6B-6D show an alternative embodiment of how a PRIVATE RATECARD can be used to enter into a contract between a buyer and a vendor. The embodiment shown in FIGS. 6B-D expands upon the embodiment shown in FIG. 6A. Referring to FIG. 6B-D, series of flowchart boxes are grouped within dotted-line boxes and each group of flowchart boxes is labeled with a circled number from 1 to 4. Circled number 1 corresponds to the first flowchart box of FIG. 6A, circled number 2 corresponds to the second flowchart box in FIG. 6A and so on.

Referring to the first dotted-line box of FIG. 6B, the first step of the specification drafting process, step 620, is to determine whether a pre-populated template exists for the job at hand. If no, a buyer enters all relevant job attributes into an empty job specification template, step 621. If yes, a buyer creates a new job specification by selecting an existing, pre-populated job specification template from a central database and modifying, if necessary, the default values on that template for the job at hand, step 622. Given the length of a precise specification for a job in some industries, such as, for example, commercial print, a database of pre-populated templates can eliminate considerable redundant data entry if the buyer performs similar classes of work on a regular basis and/or where many classes of jobs likely would share similar specifications.

Referring to the second dotted-line box of FIG. 6B, once a buyer has entered a job specification, the system of the present invention calculates the total job price by using the previously negotiated prices for each vendor stored in the system, as well as by using the pricing equations comprising the PRIVATE RATECARD to calculate each vendor's contract price for the given job, step 623. To perform these computations, the system of the present invention retrieves from the central database the vendor prices that were established at the conclusion of the Target Rate List determination process.

Further referring to the second dotted-line box of FIG. 6B, the PRIVATE RATECARD calculation process allows the system of the present invention to generate a list of vendors capable of performing the job as specified given the pricing information known to the system and informs the buyer of each vendor's total job price from the PRIVATE RATECARD calculator. Optionally, the system of the present invention can inform the buyer of differences among vendors both at the job component and the total job cost levels, thereby expsoing price variances and identifying vendor production specialties, step 624. For example, in the commercial print industry, such a comparison can be performed at the pre-press, press, finishing, and paper components of the job. This capability of the present invention allows the buyer to identify vendor production specialties and to expose otherwise hidden price variances which can provide the buyer with an informational advantage during any subsequent negotiations that may take place between the buyer and one or more of the vendors for the job.

Referring to the third dotted-line box shown in FIG. 6C, the buyer then selects a subset of vendors to participate in further negotiations for the job at hand, step 625. This step is preferable because not all vendors known to the system may be able to execute a given job. For example, some vendors may be unable to price one or more of the specifications for the job due to lack of access to certain expensive, specialized pieces of equipment required for fulfilling a given specification. Also, the buyer may optionally choose to take into account qualitative factors known only to the buyer in selecting the list of vendors to participate in further negotiations for the job.

Further referring to FIG. 6C, the buyer then can determine whether to invite one or more vendors from the selected subset of vendors to review the job specifications, step 626. For example, the buyer can engage in this activity if he is uncertain of the technical feasibility of the specification as drafted and wants to obtain confirmation from the prospective vendors working on the job as to the feasibility of the specification. This situation arises often in industries with complex specifications, and different vendors frequently adopt different strategies for overcoming technical obstacles presented by any given specification. The optional invitation process of the present invention creates a structured mechanism for dialogue to occur between buyer and vendor regarding how obstacles presented by a given specification may be overcome, while at the same time ensuring that, should modifications to the specification be required in order to overcome such difficulties, the buyer is fully informed as to the cost impact any such modifications.

If the buyer choses to notify a selected subset of vendors to review the job sepecifications, the system, in step 627, notifies the vendor or vendors selected by the buyer to review the job specifications and correct any errors or omissions. The notified vendors review the job specifications, step 628, and submit any revised specifications to the system, which in turn tabulates the specification revisions and the associated job cost impact by employing the PRIVATE RATECARD calculator on any specification revisions, step 629.

The system can perform as many iterations of the specification review process as the buyer determines are warranted. All changes to the specification and pricing are tracked by the system and stored in an associated database, so that the buyer can view the vendor responses and any corresponding price implications throughout the entire specification review process.

The buyer may also optionally engage in spot bidding, step 630, either after completing the specification review process or directly after the step 626, of selecting a subset of vendors to participate in further negotiation for the award of the job. A spot bid is described herein as a bid, submitted by a vendor to a buyer, for a given job specification which represents a one-job discount from the schedule of prices which would otherwise control the calculation of the job price as computed by the PRIVATE RATECARD calculator. Such a bid could be expressed as a percentage reduction of the total job price or as a set of percentage reductions corresponding to one or more elements of the rates comprising the PRIVATE RATECARD between vendor(s) and buyer. The present invention provides an automated means to collect and process multiple spot bids from any or all vendors selected by a buyer during a bid process for a given job.

According to this embodiment, a buyer indicates that he wishes to conduct a spot bid and then identifies the vendors with whom he desires to conduct such spot bidding. The system notifies the selected vendors of the buyer's interest in conducting a spot bid, step 631. The notified vendors then have an opportunity to submit spot bid(s), to review their previous bid(s) and to create or increase the spot bid(s) discount for a given job, step 632. The system tracks all spot bids, step 633. Optionally, the system can display to the participating vendors their relative ranking versus the other vendors at any given moment during the spot bidding process. The buyer decides when to end the spot bidding process, generally after no further bids are received from the participating vendors or after a finite amount of time has elapsed.

The spot bidding process in combination with a PRIVATE RATECARD comprises a highly effective price discovery mechanism that is able to achieve at least two objectives for a buyer. First, a PRIVATE RATECARD pricing structure between a vendor and a buyer comprises a ceiling price for many jobs comprising a broad scope of work (as contrasted with a specification for a single job) that assures a buyer of a fixed pricing structure for a set term. Second, a spot bidding capability allows a buyer to fully exploit any demand variations which create idle capacity in an industry. For example, many industries have seasonality and other load imbalances, and for these industries it is highly advantageous for a buyer to combine a ceiling-price PRIVATE RATECARD structure (which eliminates pricing “peaks”) with the ability to efficiently seek additional discounts for attributes tied to the job itself (to take advantage of any pricing “valleys”), such as the time of year in which the job is to be performed, or tied to requirements for specialized machinery when it is widely known that such machinery has seasonal demand variations.

Referring to step 634 of FIG. 6C, a buyer also may optionally engage in an auction process to contribute to the decision regarding the job award. A buyer can engage in the auction process after completing the spot bidding process and/or after completing the job specification review process, or directly after the step of selecting a subset of vendors to participate in further negotiation for the award of the job. The system of the present invention allows the buyer to conduct an auction on any portion of the job, step 635. Some job specifications may contain pricing elements that are so unique as to be difficult to calculate by using a PRIVATE RATECARD calculator. In these situations, a buyer may prefer to discover the most advantageous pricing option(s) for the unique elements of the job specification by engaging in an auction process. Many auction forms are known in the art, such as, for example, the English auction, the Dutch auction or the Vickrey auction. Since the auction process can be conducted after the spot bid process, the present invention optionally allows a buyer to combine the spot bidding process with the auction process in a consolidated spot-bid/auction for jobs that have specifications that can be only partly priced by the PRIVATE RATECARD calculator.

The reason why a buyer would employ PRIVATE RATECARD contracting supplemented by additional job-level bidding such as spot bids and auctions is that for many commercial procurements, simpler procurement processes (e.g., one job at a time price discovery or so called “bid and buy” methods) yield higher prices to the buying organization. The present invention allows the standardization and automation of these steps which constitute an advance in the art of commercial procurement price discovery.

Referring to step 636 of FIG. 6C, the buyer selects the most appropriate vendor for the job at the conclusion of the job specification review process and/or the spot bidding process and/or the auction process, or directly after selecting a subset of vendors to participate in further negotiation for the award of the job. Once a buyer selects a vendor to perform a particular print job, the system of the present invention notifies the vendor of the award, step 637. Referring to the fourth dotted-line box in FIG. 6D, the vendor then executes the job, step 638.

PRIVATE RATECARD Pricing Updates

In conjunction with the PRIVATE RATECARD schedule, a buyer and one or more of its vendors may agree to base the price for one or more of the pricing elements of a PRIVATE RATECARD on a well known, third party pricing index published on a known frequency. An example of a third party pricing index factor can be, for example, the price of market pulp in the commercial print industry. The price for market pulp is widely watched and quoted by reliable third parties in the paper industry because it is an important factor input to many grades of paper. A buyer of, for example, business forms could desire to tie the price of the paper consumed by its business forms vendors so as to constrain the paper component of the total job cost to no more than the market price of pulp times a factor negotiated between the buyer and the buyer's commercial printers. Such an arrangement would provide the buyer with complete transparency to the price determination mechanism for an important factor input in its supply chain. In this example, the important factor is the paper incorporated into the finished product purchased from the final vendor in the supply chain, which is the business forms commercial printer. A buyer desiring to establish a pricing relationship influenced by a third party pricing index factor can choose a pricing index factor which is published by a reliable third party source and then negotiate the functional relationship of the published pricing index factor to the attribute of interest in the PRIVATE RATECARD with its vendors. Buyers could use the Target Rate List determination process described above to negotiate this price.

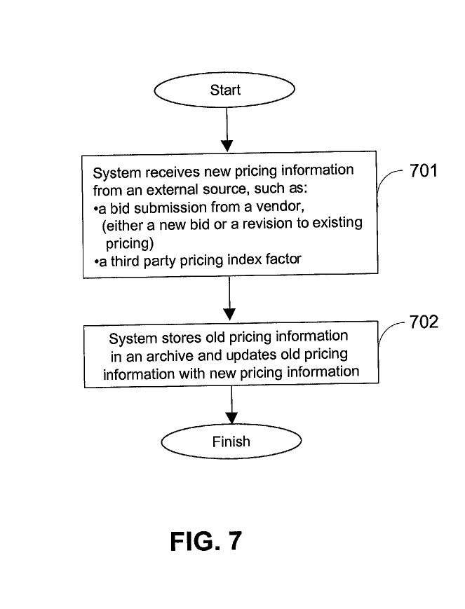

Referring to FIG. 7, step 701, a system of the present invention can receive new pricing information from a number of external sources, including information based on a third party pricing index factor or a bid submission from a vendor that either provides new pricing to a buyer or revises existing pricing previously submitted to that buyer. This information is then used to adjust the PRIVATE RATECARD calculations. Referring to step 702 of FIG. 7, as updates to the external information occur, the system of the present invention stores old pricing information in a central database and updates the old pricing information with the new pricing information. As will be apparent to one skilled in the art, an automated updating system with extremely rapid cycle times can be developed for industries that require rapid updates.

Job Specification Template Creation

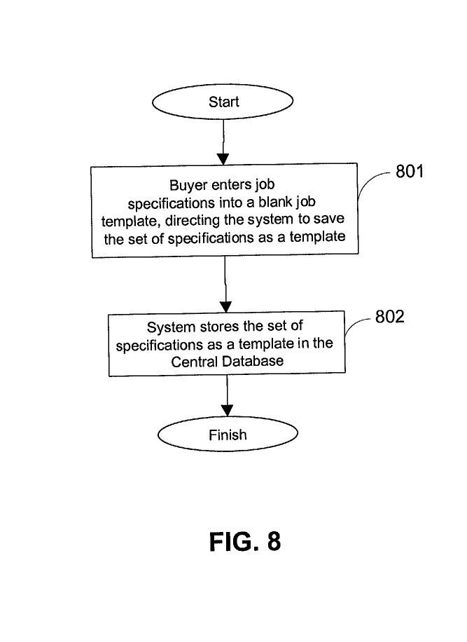

A buyer can create a job specification template for one or more classes of jobs which share common specification attributes, thus reducing data entry time in the future. Referring to FIG. 8, step 801, a buyer can enter job specifications into a blank job template, directing the system of the present invention to save the set of specifications as a template. The system of the present invention then stores the newly created template in a central database for later retrieval, step 802. The design of the templates is tied to the input parameters required by the PRIVATE RATECARD calculator, thereby insuring that job specifications which have a significant impact on cost are always specifically identified. For example, if paper-size is a critical element of the job specification, the “paper-size” field will be a required field.

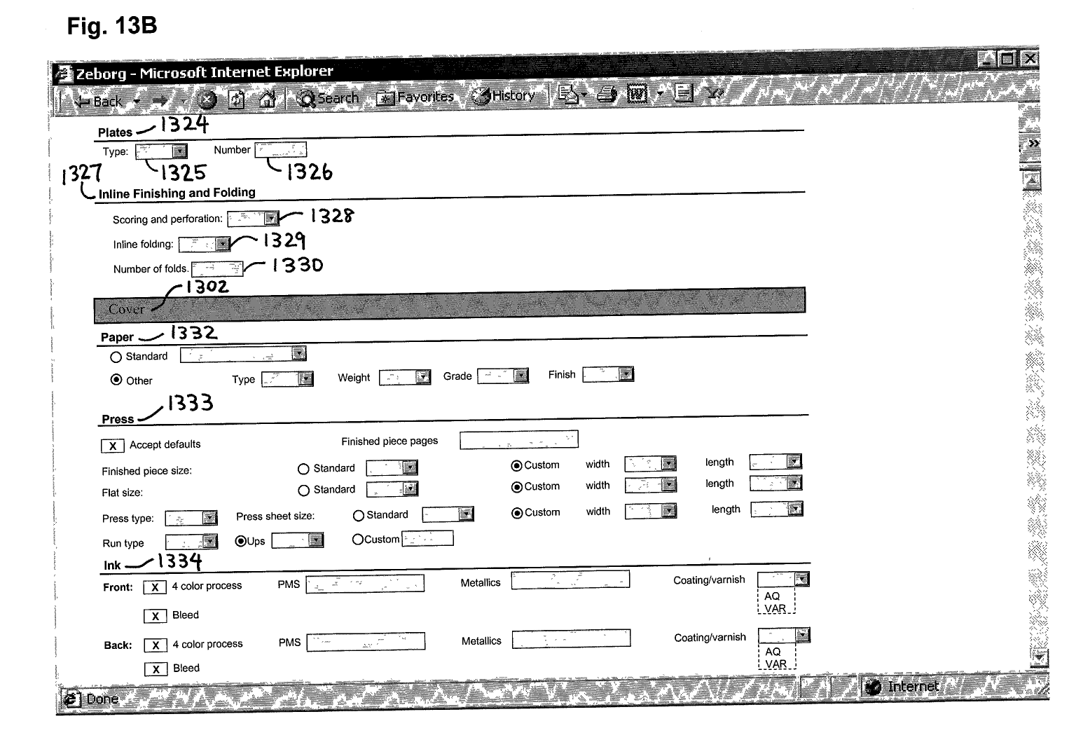

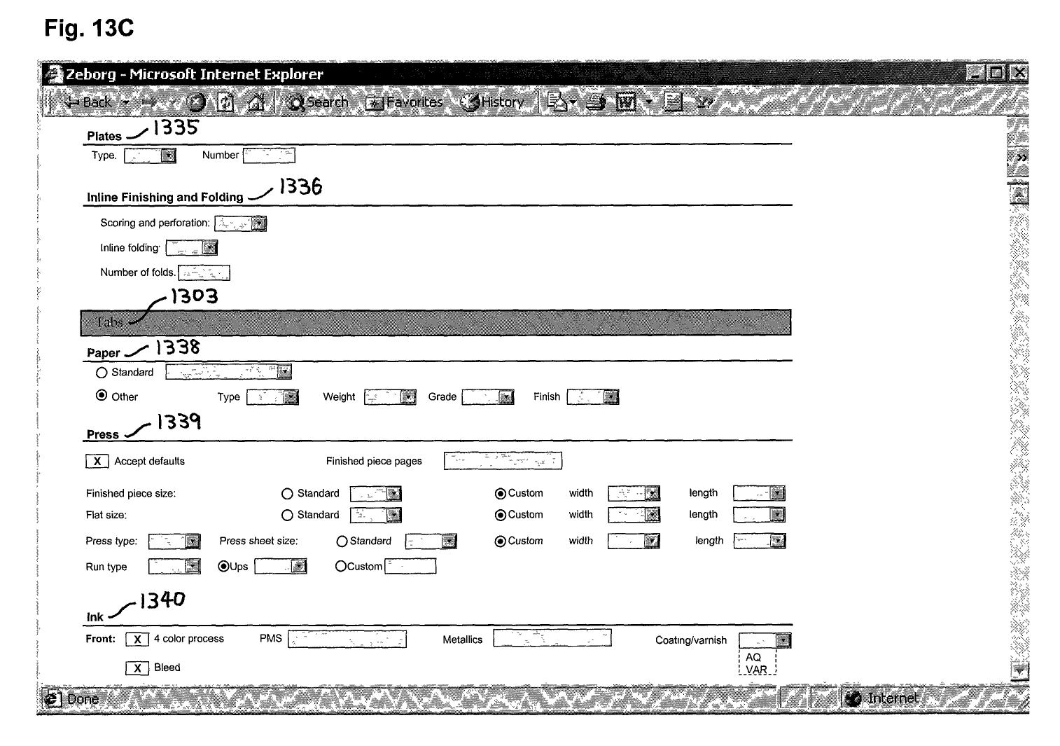

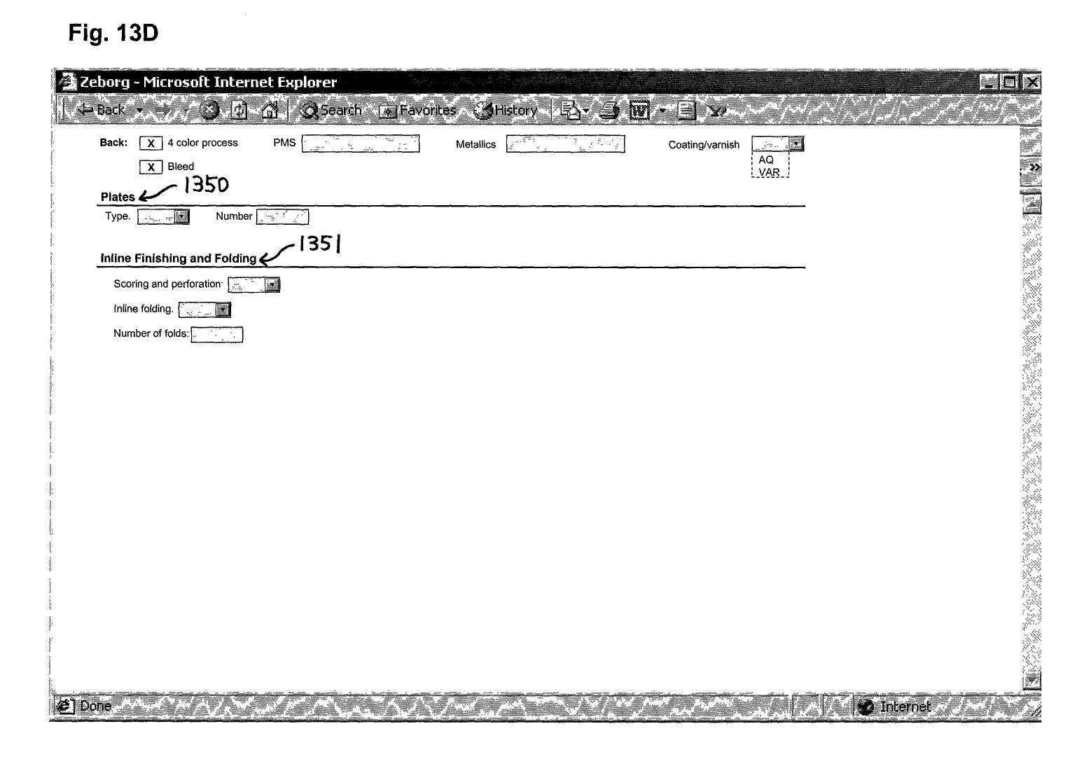

FIGS. 13A-D show several webpages containing a template for the printing industry. The template shown in FIGS. 13A-D captures the input which is needed to perform the calculations by the PRIVATE RATECARD calculator shown in FIG. 12. Referring to the webpage shown in FIG. 13A, the input includes the run output fields 1300, which determines whether the main 1301, cover 1302 and tab 1303 pages are required. FIG. 13A then shows the fields for entering specifications for the main 1301 page. FIG. 13A shows specification information for the type of paper 1305 required, including whether it is standard 1306 paper or not and, if not, the type 1307, weight 1308, grade 1309 and finish 1310 of the required paper. FIG. 13A also shows the specification information for the press 1311 requirements, such as whether defaults are accepted 1312 and information about the finished piece pages 1313, including whether the size of the finished piece pages 1313 is standard 1314 or custom 1315 and, if custom 1315, what the required width 1316 and length 1317 are; the press type 1318; the press sheet size 1319 and whether it is standard 1314 or custom 1315; and the run type 1320 and whether it is ups 1321 or custom 1315. FIG. 13A also shows fields for ink 1322 specifications, including font 1323 and back 1324 and other specifications related thereto. FIG. 13B shows further requirements for the main 1301 page, including the type 1325 and number 1326 of plates 1324 required as well as inline finishing and folding 1327 specifications, such as scoring and perforation 1328, inline folding 1329 and number of folds 1330.

Referring to the webpages shown in FIGS. 13B-13C, similar information about the specifications for paper 1332, press 1333, ink 1334, plates 1335 and inline finishing and folding 1336 is then gathered for the cover 1302 page. Referring to the webpages shown in FIGS. 13C-13D, similar information about the specifications for paper 1338, press 1339, ink 1340, plates 1350 and inline finishing and folding 1351 is then gathered for the tab 1303 page.

Templates for a PRIVATE RATECARD calculation system are designed with full knowledge of the pricing mechanics underlying the template and the job specification itself, that would ultimately be used to determine the total cost of any given job encountered by a buyer. Preferably, the templates are comprised mostly of drop down boxes or the like, and little free-form input, so as to better guide the user of the template towards entering all of the information necessary for the ultimate determination of the total cost of a given job.

Re-pricing Change Orders Using a PRIVATE RATECARD

A buyer may use a system of the present invention to re-price a change order using a PRIVATE RATECARD calculator. A conventional change order process is a process wherein either the buyer or the vendor changes the parameters of the order prior to the order's performance. The conventional change order process can occur in any industry where there is a gap in time between the moment in time that a given job is awarded and the moment in time when the specific performance related to the award occurs. For example, industries such as construction and commercial print are widely known to use change orders extensively. In the conventional change order process, either the buyer or the vendor initiates the change order, usually because of some unanticipated reason for a variance between the original job specifications and the actual job requirements.

The next step in the conventional process is for one of the two parties to write down the details of the change order, and, importantly, for the vendor to inform the buyer if the modifications reflected in the change order result in any adjustment to the overall job price. That is, in the conventional change order process, the vendor re-estimates the job price given the new specification. The receiving party (the buyer in the case of vendor-initiated change orders, but the reverse is possible as well), then must decide whether to accept the new job specification. Assuming that the receiving party accepts the new job specification and any corresponding changes in the job price, the conventional change order process ends.

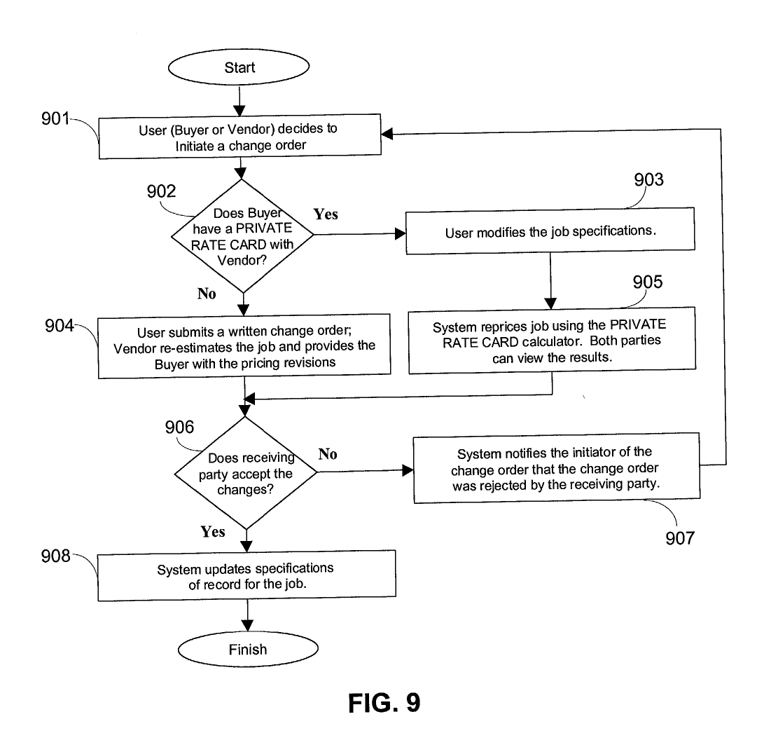

The system of the present invention differs from the conventional change order process by changing the process and mechanism by which the price of a change order is calculated. FIG. 9 shows the advantages of using a PRIVATE RATECARD as compared to the conventional change order process. As in the conventional change order process, either buyer or vendor may initiate a change order. Referring to step 901 of FIG. 9, a user of the system of the present invention, whether a buyer or a vendor, decides to initiate a change order. The next step, 902, is to determine whether the buyer has a PRIVATE RATECARD with the vendor. If so, either party can modify the specifications for the job in the PRIVATE RATECARD calculator, step 903, which displays the results to both parties, step 905. Thus, the PRIVATE RATECARD calculator and not the vendor controls the pricing of change orders. If the buyer does not have a PRIVATE RATECARD with the vendor, the party initiating the change order (the buyer, for purposes of step 904 of FIG. 9) engages in the conventional change order process, submits a written change order, the vendor re-estimates the job and provides the buyer with the pricing revisions. The next step in both situations is step 906, to determine whether party receiving the change order accepts the changes. If not, in step 907, the system of the present invention notifies the initiator of the change order that the change order was rejected by the receiving party. If the changes are accepted, in step 908, the system of the present invention updates the specifications of record for the job.

Public Pricing Index

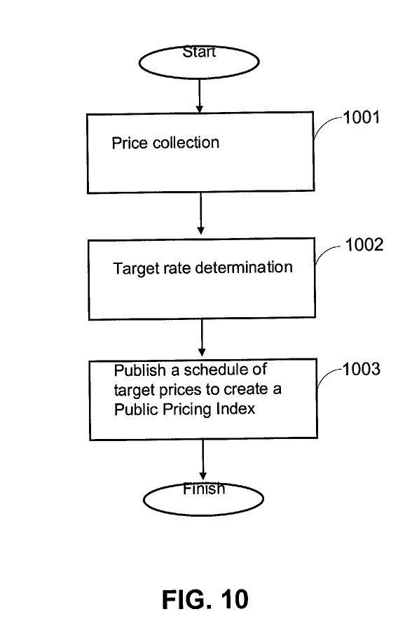

According to another embodiment of the present invention, any individual, entity or organization may publish a Public Pricing Index, containing a schedule of target prices, based on the price collection and target rate determination processes. FIG. 10 shows the price collection step, step 1001; the target rate determination step, step 1002; and the step of publishing a schedule or prices to create a Public Pricing Index.

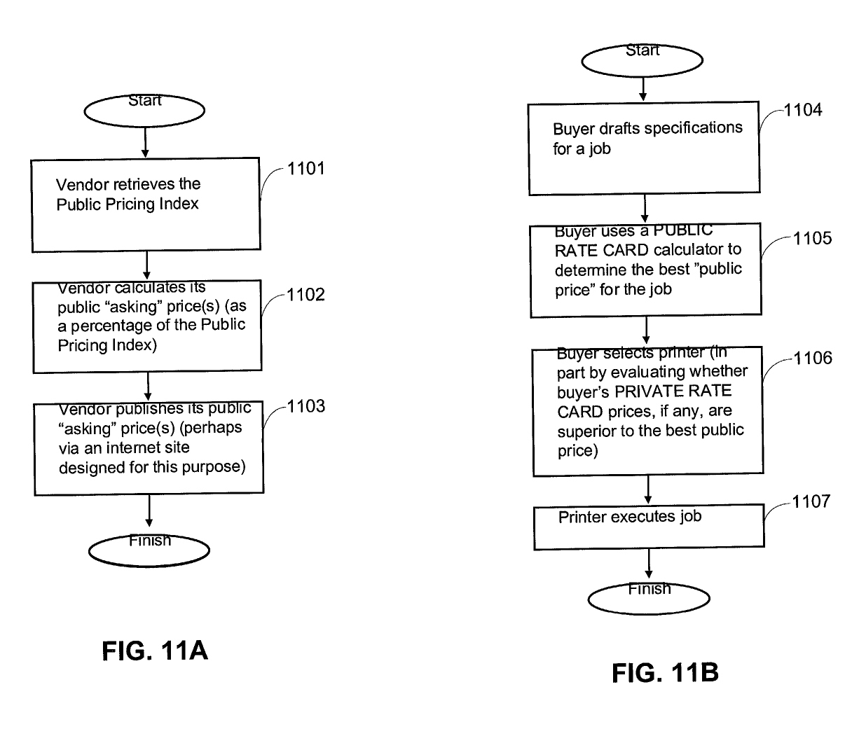

According to a further embodiment of the present invention, a vendor calculates a public asking price. As referred to herein, a public asking price is a price at which a vendor is willing and able to make available for sale the goods and/or services to which the price applies. A vendor then publishes the public asking price expressed as a percentage of, over or under, the Public Pricing Index. FIG. 11A shows the steps of a vendor retrieving the Public Pricing Index, step 1101; calculating the public asking price(s) as a percentage of the Public Pricing Index, step 1102; and publishing its public asking prices via a medium, such as the Internet, designed for this purpose, step 1103.

A vendor's public asking price also could be expressed in several hundred percentages, in a corresponding one-to-one relationship with each element in the Public Pricing Index. Also, it is possible to subdivide the hundreds of individual pricing elements involved in the printing process into a small number of buckets. The public asking price for each bucket may be expressed as a different percentage of the Public Pricing Index. For example, the public asking price for the pre-press bucket may be expressed as 5% over the corresponding bucket in the Public Pricing Index whereas the public asking price for the off-line finishing bucket may be expressed as 4% under the corresponding bucket in the Public Pricing Index.

A vendor's published public asking price is referred to herein as a PUBLIC RATECARD. A PUBLIC RATECARD may be expressed as a percentage of the corresponding Public Pricing Index or an actual dollar figure. The PUBLIC RATECARD may be posted on a website designed for this purpose or published by any other means known in the art.

A buyer is able to review all of the PUBLIC RATECARDS published, preferably via a website designed for this purpose, preferably by means of a look up engine or a search engine. Most preferably, the buyer is able to compare the pricing information in the published PUBLIC RATECARDS across relevant elements or buckets. Upon completion of the review, a buyer may contract with any of the vendors as desired.

Alternatively, referring to FIG. 11B, a buyer may draft a specification for a job, step 1104, and then use a PUBLIC RATECARD calculator to determine the best public price for the job, step 1105. On any given job, it is likely that only a fraction of the hundreds of prices comprising the structure of a PUBLIC RATECARD are relevant to that job. Furthermore, of the small number of relevant prices, a select few values will be determinative of the lowest price vendor for each job. In drafting a specification for a job, a buyer may use a pre-existing template or a blank template from a central database, as disclosed above in reference to PRIVATE RATECARD contracting. A PUBLIC RATECARD calculator derives a final contract price similarly to the way a PRIVATE RATECARD calculator does so. In addition, a PUBLIC RATECARD calculator is able to inventory and locate the PUBLIC RATECARDS wherever they are published. This may achieved by any means known in the art.

The buyer then selects a vendor best suited for the job. Preferably, referring to FIG. 11B, the buyer's evaluation includes a comparison, step 1106, of the best PUBLIC RATECARD prices with the best PRIVATE RATECARD prices available to the buyer. This may be possible, for example, by comparing the output from the PRIVATE RATECARD calculator with the output from the PUBLIC RATECARD calculator. The printer then executes the job, step 1107.

Furthermore, in reaching a contract between a buyer and a vendor, the PUBLIC RATECARD can be supplemented by the spot bid and/or auction processes disclosed above in reference to PRIVATE RATECARD contracting. Also, if new pricing information is received, the PUBLIC RATECARD calculator can be updated in the same manner as the PRIVATE RATECARD calculator, disclosed above.

Re-Pricing

Re-pricing of Public Pricing Index, PRIVATE RATECARDS and PUBLIC RATECARDS can be achieved by repeating the price collection and target price determination steps according to this invention. However, in another embodiment of the invention, a more economical re-pricing method is available. For example, if due to shortage the price of offset text paper stock should rise by 15%, it is then a quick and straight forward matter to adjust the corresponding elements of any or all of the following: Public Pricing Index, a PUBLIC RATECARD or a PRIVATE RATECARD.

It will also be understood that the specification, Figures, examples and Tables are illustrative of the present invention and that other embodiments within the spirit and scope of the invention will suggest themselves to those skilled in the art.

All references cited herein are incorporated by reference.

TABLE 1
Zeborg Indirect Expense Classification Hierarchy

| Category - Level 1 | Sub-Category - Level 2 | Sub-Category - Level 3 | Sub-Category - Level 4 |
|---|---|---|---|
| Marketing & | Agency Compensation | Advertising Agency Compensation | |
| Advertising | | Direct Mail Agency Compensation | |
| | Mass Media | Network TV | |
| | | Spot TV | |
| | | Cable TV | |
| | | Radio | |
| | | Outdoor | |
| | | Print Media | Magazine Placements |
| | | | Newspaper Placements |
| | | Internet | |
| | | Sponsorships | |
| | | Celebrity Talent | |
| | | Advertising Production | |
| | | Media - Other | |
| | Direct Media | Commercial Print | |
| | | Design Fees | |
| | | Direct Mail | DM/Preproduction |
| | | | DM/Lists |
| | | | DM/Brochures |
| | | | DM/Envelopes |
| | | | DM/Forms |
| | | | DM/Lettershop |
| | | | DM/Paper |
| | | | DM/Postage |
| | | Catalog Printing | |
| | Financial Printing | Research Report Printing | |
| | | Prospectus Printing | |
| | | Annual Report | Design |
| | | | Printing |
| | | | Paper |
| | Market Research | Qualitative | |
| | | Quantitative | |
| | Telemarketing | Inbound Telemarketing | |
| | | Outbound Telemarketing | |
| | Promotional Materials & | | |
| | Programs | | |
| | Trade Shows & Conventions | | |
| | Event Marketing | | |
| Technology | Mainframe Complex | CPU | |
| | | CPU-Related | ESCON Directors |
| | | | Other CPU Related |
| | | Storage | DASD |
| | | | Optical |
| | | | Cartridge |
| | | | Other Storage |
| | | Mainframe Printers | |
| | | Terminals | |
| | | Mainframe Services | Mainframe Maintenance |
| | | | Disaster Recovery |
| | Distributed Computers | PC Desktops | |
| | | PC Laptops | |
| | | PC Peripherals | |
| | | Server Hardware | |
| | | Printers | |
| | | Distributed Services | VAR |
| | | | MAC (Move, Add, Change) |
| | | | Break/Fix |
| | | | Rollout |
| | Software | Mainframe-System Software | |
| | | Mainframe-Application Software | Licenses |
| | | | Maintenance |
| | | Distributed Software | Licenses |
| | | | Maintenance |
| | Telecommunications | Equipment | End User Devices |
| | | | PBXS |
| | | | Hubs |
| | | | Routers |
| | | | LAN Switches |
| | | | Maintenance |
| | | Lines & Tolls | Dedicated Leased Lines |
| | | | Local Service & Access |
| | | | Long Distance - Domestic |
| | | | Long Distance-International |
| | | Telecomm Services | Audio Conferencing |
| | | | Cellular/Paging |
| | | | Bulk Fax |
| | | | Telex |
| | | | Telecomm - Other Services |
| | Contract Programming | Contract Programming - Domestic | |
| | | Contract Programming - Offshore | |
| | Other Technology | Other Technology | |
| Facilities | Space | Rent/Leased Space | |
| | | Depreciation/Owned Space | |
| | Alteration/Capital Improvement | | Alteration/Capital Improvement |
| | Utilities | Electric | |
| | | Gas | |
| | | Water | |
| | Building Services | Security | Security Systems |
| | | | Security Guards |
| | | Cleaning | Cleaning - Base Building |
| | | | Specialty Cleaning |
| | | Repairs & Maintenance | Maintenance T&M |
| | | | Supplies |
| | | HVAC | HVAC |
| | | Vertical Transport | Elevator |
| | | | Escalator |
| | | Rubbish Removal | Rubbish Removal |
| | | Catering | Cafeteria Services |
| | | | Other Catering |
| | | Grounds | Landscaping |
| | | | Equipment |
| | | Vending | Vending |
| | Office Furniture | Office Furniture | |
| | Fixtures & Fittings | Signage | |
| | | Fixtures & Fittings | |
| | Property Management | Property Management Fees | |
| | Other Facilities | Other Facilities | |
| Overhead | Business Forms | Stock Business Forms | |
| | | Stock Envelopes | |
| | | Stock Paper | |
| | Office Supplies | Office Supplies | |
| | Stationery | Stationery | |
| | Records Management | Records Management | |
| | Microfiche | Microfiche | |
| | Office Equipment | Copy Machines | |
| | | Fax Machines | |
| | | Office Equipment - Repair | |
| | | & Maintenance | |
| | Warehouse | Warehouse | |
| | P.E.&C. | Postage | Domestic |
| | | | Foreign |
| | | Express Mail | Domestic |
| | | | Foreign |
| | | Courier | |
| | Freight | LTL | |
| | | Truckload | |
| | Printing, n.e.c. | Outside Quick Printing | |
| | | Newsletters | |
| | | Directories | |
| | | Other Printing, n.e.c. | |
| | T&E | Airlines | |
| | | Hotel | |
| | | Car Rental | |
| | | Car Services/Limousines | |
| | | Taxis | |
| | | Rail | |
| | | Personal Car Mileage | |
| | | Fleet Vehicles | Fleet Vehicles |
| | | | Fleet Parking |
| | | Special Events/Conventions | |
| | | Travel Agency Fees | |
| | | Other T&E | |
| | Dues & Subscriptions | Dues & Memberships | |
| | | Library Services | |
| | | Subscriptions | |
| | Corporate Insurance | Liability | D&O |
| | | | E&O |
| | | Property Damage | Corporate Auto |
| | | | Fire |
| | Mail Room | Mail Room | |
| | Other Overhead | Other Overhead | |
| Personnel Related | Plan Administration | Plan Administration Fees | |
| | Healthcare Benefits | Healthcare - Self Insured Benefit | |
| | | Claims | |
| | | Healthcare - Indemnity Plan | |
| | | Premiums | |
| | | Healthcare - PPO Fees | |
| | | Healthcare - HMO Fees | |
| | Non-Health Care Benefits | Pension Plan | |
| | | 40 1(k) Plan | |
| | | Dental Plan | |
| | | Vision Plan | |
| | | Prescription Plan | |
| | | Labwork Plan | |
| | | Workers Comp | |
| | | Accidental Death | |
| | | ST Disability | |
| | | LT Disability | |
| | | Life Insurance | |
| | | Expatriate | |
| | Training | Outside Training Firms | |
| | | Internet Delivered Training Fees | |
| | Recruitment | Recruitment Fees | |
| | Relocation | Relocation Fees | |
| | Professional Services | Legal Fees | |
| | | Management Consulting Fees | |
| | | Bank Fees | |
| | | Audit & Tax Fees | |
| | Temporary Services | Temporary Service Agencies | |
| | | Payrolling Services | |
| | Other Personnel Related | Other Personnel Related | |
| Business Specific | Card Services | Card Member Benefits/Insurance | |
| Financial Services | | New Account Processing | |
| Example | | Travel Accident Insurance | |
| | | Collision Damage Waiver | |
| | | Retail Services | |
| | | Credit Bureau Fees | |
| | | Collection Agency Fees | |
| | Market Data | Market Data | |
| | Financial Supplies & Services | Check Printing | Plastic Card Issuance |
| | | Travelers Checks | |
| | | Deposit Bags | |
| | Equipment | ATMs | Housings |
| | | | Self-Service Terminals |
| | | | Servicing |
| | | MICR Encoders | |
| | | Check Printers | |
| | | POS Terminals | |
| | Armored Car | Armored Car | |
| | Wholesale Lockbox | Wholesale Lockbox | |
| Unsourceable | Unsourceable | | |

© 2000 Zeborg, Inc.

### EXAMPLE 1

### PRICE COLLECTION IN THE COMMERCIAL PRINT INDUSTRY

The present invention collects a standardized template of print pricing information from multiple vendors and places this data into a database. The standardized template of print pricing information is as follows:

| | | FORM |
|---|---|---|
| FORM DESCRIPTION | | NUMBER |
| 1. | Business Background | |
| | Company Information: Business Background | A-1 |
| | Company Information: Machinery and Capabilities | A-2 |
| | Company Information: Growth and Replacement | A-3 |
| | Company Information: Turnaround | A-4 |
| 2. | Pre-Press | |
| | Paper Pricing: Book | B-1A |
| | Paper Pricing: Cover | B-1B |
| | Pre-Press: Scanning, Graphics, Film | B-2 |
| | Pre-Press: Proof Production, Misc. Pre-Press | B-3 |
| 3. | Die Manufacturing | |
| | Die Manufacturing | B-4 |
| 4. | Press | |
| | Press: Small Sheetfed | B-5 |
| | Press: Large Sheetfed | B-6 |
| | Press: Half-Web | B-7 |
| | Press: Full-Web | B-8 |
| | In-Line Finishing | B-9 |
| 5. | Post-Press/Off-Line Finishing | |
| | Post-Press Finishing | B-10 |
| | Off-Line Folding | B-11 |
| | Binding | B-12 |
| 6. | Packing, Shipping and Warehousing | |
| | Packing and Fulfillment | B-13 |

1. Business Background

### Forms: A-1, 2, 3, 4

The vender logs onto the system at a user terminal by entering a user id and a password. When the computer has verified that the vendor is an authorized user, the vendor is permitted to enter the database and begin the completion of the template. The vendor is provided a range of documents to select (Forms A-1 through B-13). All of the documents listed on the contents screen must be completed by the vendor.

Once the vendor has successfully accessed the first series of templates (Forms A-1 through A-4), the vendor is asked to supply overall print capacity, available resources, and general background information, machinery and anticipated growth of the business, and/or replacement costs for obsolescent machinery. The vendor is also asked to provide data regarding plant turnaround proficiency and speed of print production. After this information has been placed in the database, the vendor can click on the next document listed in the table of contents.

### Form: B-1a/b Paper Pricing (Book/Cover)

| Component | Worksheet |
|---|---|
| Paper - Book | Form B-1a |
| Paper - Cover | Form B-1b |

When documents B-1a and B-1b are opened, the vendor is requested to enter information regarding the stock color, finish, and weight of the papers that could be used in the print production process. The vendor is then requested to provide pricing for book and cover papers. For each given combination of color, finish, and weight, the vendor is requested to indicate both the manufacturer and brand of the paper that would be furnished on a future job. The vendor then provides sheet and roll prices in terms of dollars per hundred pounds for each of these paper types.

2. Pre-Press

### Form: B-2 Scanning, Graphics, Film

The vendor completes forms B-2 and B-3 and provides pricing information concerning the vendor's ability to supply the high-quality pre-press work.

| Component | Worksheet |
|---|---|
| Scanning | Form B-2 |
| Graphics | Form B-2 |
| Film Production | Form B-2 |

a. Scanning

The vendor indicates scanning prices in terms of dollars per scan for halftone, duotone, and four-color scans for each of the transparency size ranges listed on the first table of the template. Drum scan quality level is required for this process, although those skilled in the art would immediately realize that many different quality levels could be specified for this step.

b. Graphics Manipulation

The vendor provides prices in terms of dollars per hour for standard (Mac time) and complex (Scitex-level studio time) computer graphics work. The vendor is also requested to include the price per hour for typesetting services.

c. Film Production

The vendor enters film production prices in terms of dollars per film for each of the film size ranges listed. Vendors supply prices for a new film from a digital file, as well as for duplicate film from a master.

Itemized Operations: The vendor is also asked to quote prices in terms of dollars for the following itemized operations based on the image size to be manipulated. The vendors skilled in the art are familiar with the following:

Transformation/Resizing: Resizing and stripping an image from an existing image (with pricing based on finished size)

Master and Marks: Price to insert crop marks, gutters, and trim

Create UPC: Price to create a new barcode

### Form: B-3 Pre-Press

d. Proof Production

The vendor estimates the cost of producing a one-sided proof in terms of dollars per proof by proof type and size listed on the table. Pricing includes all of the following proof types:

Blueline Composite (e.g., Dylux)

Digital Color (e.g., Iris, Kodak)

Integral (e.g., Cromalin, Matchprint)

Overlay (e.g., Color Key, Cromacheck)

Press Proof (e.g., progressive proof)

e. Table Stripping

Most stripping, when required, will be performed electronically. However, for the manual table stripping requests, the vendor indicates a single rate in terms of dollars per hour in the space provided in the table. Note that this charge is only applicable when stripping results from an author's alteration change. As is customary in the trade, printers are expected to cover the costs of corrections resulting from their own errors.

f. Platemaking

In this section, the vendor determines prices in terms of dollars per plate for each standard and digital (e.g., direct-to-plate) plate produced for a job by size of plate. This price should not include the price to produce any film, even if these films are used during the platemaking process. The price for film production was covered in part “c” above.

g. CD-R Production

In this section, the vendor enters the price in terms of dollars per megabyte for burning data onto a CD-ROM.

3. Die Manufacturing

### Form: B-4 Die Manufacturing

Once the information concerning pre-press has been entered, the vendor advances to Form B-4. The vendor determines the cost of producing a die by the level of complexity, given a defined die material (e.g., brass), used in constructing the pricing quote. Die manufacturing pricing consists of a flat set-up fee per die, regardless of level of complexity, in addition to a charge per inch of laid rule given a defined die material. Die types are categorized as follows:

Simple Straight-line design (e.g., rectangular window)

Moderate Designs that include angles or curves (e.g., rectangular window with constant radius rounded corners, star cut-out, etc.)

Complex Designs with intricate shapes or several small angles and/or curves (e.g., outline of text and graphic element)

4. Press

### Forms: B-5 Small Sheet-fed, B-6 Large Sheet-fed

### B-7 Half-Web, B-8 Full-Web, and B-9 In-Line Finishing

Forms B-5 through B-9 contain instructions for all press-related job costs, including in-line finishing. The vendor addresses each Form separately. The vendor also calculates the pricing for the various press and color scenarios provided on the forms.

| Component | Worksheet |
|---|---|
| Small Sheetfed Press | Form B-5 |
| Large Sheetfed Press | Form B-6 |
| Half-Web Press | Form B-7 |
| Full-Web Press | Form B-8 |
| In-Line Finishing | Form B-9 |

a. Assumptions and Notes

Small Sheetfed Press: The vendor bases quotes on a standard commercial sheetfed press printing on 60# text to 100# text coated stock with an impression size of 20×28 inches or smaller. Pricing is based on single-sided impressions for a single-sided press and double-sided impressions for a perfecting press.

Large Sheetfed Press: The vendor bases quotes on a standard sheetfed press printing on 60# text to 100# text coated stock with an impression size of 28×40 inches. Pricing is based on single-sided impressions for a single-sided press and double impressions for a perfecting press.

Half-Web Press: The vendor bases quotes on a standard commercial half-web press printing on 60# text to 100# text coated stock with an impression size of 19×25 inches and assumes a run size of 15,000-100,000+ impressions. In addition, half-web press pricing is assumed to be perfecting (e.g., 1 impression will produce 1 two-sided press sheet).

Full-Web Press: The vendor bases quotes on a standard commercial full-web press printing on 60# text to 100# text coated stock with an impression size of 25×38 inches and assumes a run size of 50,000+ impressions. In addition, full-web presses are assumed to be perfecting (e.g., 1 impression will produce 1 two-sided press sheet).

b. Ink Numbering

Many press operations require pricing based on the number of inks used during a given press run. In order to accurately reflect the costs and operations associated with the different printing methods, the system requires the vendor to use the following ink numbering standards when quoting prices:

Perfecting (Web and Sheetfed Presses) and Work and Turn: Setup and run-rate ink count is equal to the number of plates used in the press run, excluding those plates changed mid-run to produce a multiple piece version. Thus, on a perfecting press, a 4/4 run will be an 8-ink run and a 4/1 run will be a 5-ink run. In the work and turn process, a 4/4 run will be a 4-ink run, assuming a CMYK/CMYK color distribution. A 4/1 run would also be a 4-ink run if the color distribution were CMYK/K while it would be a 5-ink run if the single reverse color did not match one of the colors on the front of the sheet (e.g., CMYK/PMS1). Note that in the case of a two-sided work and turn job, each press sheet will require two impressions in order to print a single print sheet.

Sheetwise: The set-up ink count will be priced according to the total number of plates used in the printing run. Thus, a 4/4 run would be an 8-ink run and a 4/1 run would be a 5-ink run. The vendor prices the rates per impression on each side separately and is asked to base this price on the number of colors to print on a single side. Thus, of the two impressions used to print a two-sided press sheet, one would be priced according to the number of colors on the front while the other would be priced according to the number of colors on the back.

The tables and examples below summarize the pricing standards. Table 1 summarizes the pricing basis for the different printing methods. Table 2 contains a series of examples that outline the application of these ink counting methods for various piece types and printing methods.

TABLE 1
Press Pricing Basis

| Printing | Pricing Basis | |
|---|---|---|
| Method | Setup | Run Rate |
| Perfecting | total # of plates used during | Total # of plates used* |
| | a run* | |
| Work and Turn | total # of plates used during | Total # of plates used* |
| | a run* | |
| Sheetwise | Total # of plates used during | Front and back priced |
| | the run* | separately based on the # |
| | | of plates used during |
| | | each run* |

*Plate count does not include plates changed mid-run to create multiple versions

TABLE 2
Ink Count Examples

| | | | Setup | Run Rate |
|---|---|---|---|---|
| | | Colors | Ink Count | Ink Count |
| Example | Print Method | Front/Back | Colors | Colors |
| 1 | Perfecting | CMYK/Black | 5 | 5 |
| 2 | Perfecting | CMYK/CMYK | 8 | 8 |
| 3 | Perfecting | CMYK + PMS1/ | 7 | 7 |
| | | Black + PMS2 | | |
| 4 | Work and Turn | CMYK/Black | 4 | 4 front |
| | | | | 4 back |
| 5 | Work and Turn | CMYK/CMYK | 4 | 4 front |
| | | | | 4 back |
| 6 | Work and Turn | CMYK + PMS1/ | 6 | 6 front |
| | | Black + PMS2 | | 6 back |
| 7 | Sheetwise | CMYK/Black | 5 | 4 front |
| | | | | 1 back |
| 8 | Sheetwise | CMYK/CMYK | 8 | 4 front |
| | | | | 4 back |
| 9 | Sheetwise | CMYK + PMS1/ | 7 | 5 front |
| | | Black + PMS2 | | 2 back |

Note:
PMS1 and PMS2 are used to represent dissimilar, non-CMYK colors

All pricing examples demonstrate the pricing of 1000 finished press sheets.

### Example 1

Perfecting Press, CMYK front over proprietary purple

Setup Cost: 5-ink setup charge

Run Cost: 1000×5-ink run rate

### Example 2

Perfecting Press, CMYK over CMYK

Setup Cost: 8-ink setup charge (CMYK+CMYK)

Run Cost: 1000×8-ink charge

### Example 3

Work and Turn Press, CMYK+proprietary green front over proprietary red

Setup Cost: 6-ink rate (CMYK+proprietary green+proprietary red)

Run Cost: 2000×6-ink rate (2000 impressions required to produce 1000 two-sided sheets)

### Example 4

Work and Turn Press, CMYK front over black

Setup Cost: 4-ink rate (Reverse black is covered in CMYK setup)

Run Cost: 2000×4-ink rate

### Example 5

Sheetwise Press, CMYK front over proprietary blue

Setup Cost: 5-ink rate (CMYK+proprietary blue)

Run Cost: 1000×4-ink rate (CMYK front)+1000×1-ink rate (proprietary blue black)

### Example 6

Sheetwise Press, CMYK front over black

Setup Cost: 5-ink rate (reverse black must be re-setup for reverse printing)

Run Cost: 1000×4-ink rate+1000×1-ink rate

c. Printing

The vendor completes Forms B-5 through B-8 as follows:

Press Operations Standard Ink Coverage. The vendor completes this section separately for each of the four press types listed on Forms B-5 through B-8. The vendor provides, as indicated, a price based on the number and type of inks and finishes.

Paper. The vendor supplies the amount of paper (in press sheets) needed to get a sheetfed, half-web, or full-web press to grade for printing. The vendor then provides post-setup (i.e. run) paper waste rates (as a percent of run consumption) for each press type.

Press. The vendor calculates prices in dollars for setting-up sheetfed, half-web, and full-web presses, excluding all paper-related setup costs. The vendor then provides a rate in terms of dollars per thousand impressions for running each press according to the various ink count assumptions. These prices should include all non-paper costs, including employee time, machine time, and ink costs.

Adjustment Factors. Forms B-5 through B-8 allow for certain adjustments in standard press pricing as follows:

Versions. On Forms B-5 through B-8, the vendor provides a single price in dollars per plate changed for a single plate mid-run on small sheetfed, large sheetfed, half-web, and full-web presses respectively. The vendor excludes plate production costs in this price. Heavy Ink. Heavy ink coverage denotes press sheet coverage of 70% or greater per color. The vendor determines the press run rate for a heavy ink job by multiplying the base rate by an adjustment factor (e.g., an adjustment factor of 0.065 would indicate that it is 6.5% more expensive to run a heavy ink job than a standard job. Therefore, a standard run rate given would be multiplied by 1.065 in order to arrive at its corresponding heavy ink run rate). The vendor provides a single adjustment factor (percent) to the press run rate for heavy ink coverage on each of the following press types: sheetfed, half-web, and full-web. The relevant spreadsheets are Forms B-5 through B-8 respectively.

Light Ink. Light ink coverage denotes press sheet coverage of 40% or less per color. The vendor determines the press run rate for a light ink job by multiplying the base rate by an adjustment factor (e.g., an adjustment factor of 0.065 would indicate that it is 6.5% less expensive to run a light ink job than a standard job. Therefore, a standard run rate given would be multiplied by 0.935 (1-0.065) in order to arrive at the corresponding light ink run rate). The vendor also provides a single adjustment factor (percent) to the press run rate for light ink coverage on each of the following press types: sheetfed, half-web, and full-web. The relevant spreadsheets are Forms B-5 through B-8 respectively.

Heavy Stock In order to compensate for the slower press speeds and additional makeready requirements for printing on heavier papers (defined as 100# cover stock and heavier), these factors increase the associated printing costs by a flat number of sheets for setup, a percentage scaling factor for waste rate, a flat dollar run setup amount, and an extra $/m per 1,000 impressions.

d. In-Line Finishing

The vendor supplies in-line finishing prices on Form B-9 as follows:

Aqueous Coating. The vendor prices in-line aqueous coating on small sheetfed, large sheetfed, half-web, and full-web presses. The vendor lists setup and run prices in terms of dollars per thousand impressions separately for each press type. The setup price covers both one- and two-sided coating while the run rate is tabulated on a per side basis.

Scoring/Perforation. The vendor prices unidirectional in-line scoring and perforation on small sheetfed, large sheetfed, half-web, and full-web presses. The vendor provides setup (in dollars) and run prices (in terms of dollars per thousand press sheets) separately. The vendor also assumes the same pricing for scoring and perforation.

Folding. The vendor prices in-line folding on half-web and full-web presses. The vendor is asked to enter rates for standard signature and basic (parallel, letter, accordion, etc.) folds separately. Standard signatures are defined as 8 pages for half-web and 16 pages for full-web presses. The vendor should also assume a 4×9 inch panel size for piece folding.

Flood Varnishing. The vendor supplies prices for in-line flood varnishing on small sheetfed, large sheetfed, half-web, and full-web presses. The vendor provides setup (in dollars) and run prices (in terms of dollars per thousand impressions) separately for each press type. The setup cost covers both one- and two-sided flood varnishing while the run rate is per side.

Trimming. The vendor prices in-line trimming on half-web and full-web presses. The vendor prices setup (in dollars) and run (in terms of dollars per thousand press sheets) separately.

Die Cutting. The vendor prices in-line die cutting on half-web and full-web presses. The vendor supplies the setup rate (in dollars) and run rate (in dollars per thousand press sheets). The vendor excludes die manufacturing costs from the price, as those costs been supplied in a previous form.

5. Post-Press/Off-Line Finishing

B-10 Post-Press Finishing

Significant post-press work is generally required on most print jobs. Consequently, the vendor uses Forms B-10 through B-12 to enter post-press finishing pricing and as service offering abilities dictate.

a. Off-Line Trimming

Trimming is priced per pound of paper trimmed. On Form B-10, the vendor supplies setup (in dollars) and run (in dollars per pound of paper trimmed) prices charged for off-line trimming for each of the four cut ranges listed. However, the vendor should not price trimming performed by stitching or folding equipment on this form.

b. Off-Line Scoring and Perforation

The vendor supplies price off-line scoring and perforation rates based on a setup (in dollars) and run (in dollars per thousand press sheets) basis. In addition, the vendor provides both unidirectional and bi-directional scoring/perforation prices on Form B-10.

c. Off-Line Die Work

The vendor provides setup (in dollars) and run costs (in dollars per thousand press sheets) for the four off-line die processes on Form B-10: cutting, embossing/debossing, foil stamping, and folder pocket stamping. Die manufacturing costs should be excluded from the prices quoted.

d. Folder Pocket Construction

For each of the four folder types (unglued, one-side glued, and two-side glued) listed on Form B-10, the vendor supplies setup pricing (in dollars) and run rate pricing (in dollars per thousand finished pieces). It is important to price each case individually (e.g., not as additional charges to a base rate).

e. Ultraviolet Coating

In this section, the vendor provides setup pricing (in dollars) and run pricing (in dollars per thousand press sheets) prices for spot ultra-violet coating.

f. Spot Varnish

In this section, the vendor supplies setup pricing (in dollars) and run pricing (in dollars per thousand sheets) for spot varnishing.

g. Wafer Sealing

The vendor supplies pricing for single and double wafer seals on a one-time setup (dollars) and run (dollars per thousand sealed pieces) basis. The vendor assumes that one and two seals would be applied to 4×9 and 9×12 inch brochures respectively.

h. Gluing

The vendor prices setup and run costs for strip gluing such as pocket folder construction by length of glue strip per piece (<10″, 11-20″, 21-30″). The vendor supplies both setup and run rate (dollars per thousand finished pieces). The vendor should exclude any costs for subsequent folding of the piece in the prices quoted in this section.

### Form: B-11 Off-Line Folding

i. Folding

The vendor-quotes a setup charge (in dollars) and run rates for sheet folding (in dollars per thousand press sheets) and piece folding (in dollars per thousand finished pieces) based on fold type. Note that “basic” folds include, but are not limited to, parallel roll, accordion, and letter folds. For piece folding, the vendor should assume a 4×9 inch panel size.

### Form: B-12 Binding

j. Saddle Stitching

This system standardizes the individual trimming, collation, final folding, and stitching functions performed by many different saddle stitching machines as one process. The vendor prices saddle stitching by providing a setup (in dollars) and run price (in dollars per thousand stitched pieces) for the 4×9 and 9×12 inch finished work scenarios listed in the table.

k. Perfect Binding

This system standardizes the trimming, collation, final folding, and binding functions performed by many different machines as one process. On Form B-1 2, the vendor prices perfect binding with a single setup (in dollars) and run (in dollars per thousand finished pieces) prices for the perfect binding of booklets for both 4×9 inch and 9×12 inch sizes.

### Form: B-13 Packing and Fulfillment

6. Packing, Shipping and Warehousing

The vendor uses Form B-13 to supply prices for packing, shipping and warehousing services.

a. Shrink Wrapping

The vendor enters setup pricing (in dollars) and run pricing (in dollars per thousand finished pieces) for shrink-wrapping sets of 25, 50, and 100 finished pieces. The vendor should assume that finished pieces are cover+8 pages and have finish size of 4×9 inches.

b. Paper Wrap

The vendor enters pricing setup (dollars) and run pricing (in dollars per thousand finished pieces) for paper-wrapping sets of 25, 50, and 100 finished pieces. The vendor should assume that finished pieces are cover +8 pages and have finish size of 4×9 inches.

c. Small Parcel Shipping

The vendor provides prices for small parcel shipping of disks, proofs, and samples via overnight carrier and messenger (where applicable for local deliveries). These prices should not include delivery of the product run itself.

d. Other Operations

The vendor is required to base the cost for items such as palletizing and related operations on a per pallet charge for each operation.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1. A method of standardizing price discovery and negotiation using a computer processing system comprising:
receiving at least one demand set comprising a buyer's specifications for performance elements;
associating with said demand set at least one vendor bid; and
analyzing the at least one vendor bid to identify a preferred bid for each performance element.

2. A method of claim 1, wherein the preferred bid consists of a group of a lowest bid, an nth lowest bid, a mean bid and a median bid.

3. The method of claim 1, wherein the demand set comprises specifications selected from the group consisting of specifications for performance elements which the buyer demanded in the past, specifications for performance elements which the buyer expects to demand in the future and a combination thereof.

4. The method of claim 1, further comprising compiling a target schedule of the preferred bid for each element, wherein vendors on the target schedule agree to become contractually bound to provide services to the buyer at the prices listed on the target schedule for a predetermined amount of time.

5. The method of claim 1, further comprising:
publishing a target schedule of preferred bid for each performance element;
compiling an individual schedule of a single vendor's bid for at least one performance element, wherein the single vendor's bid is a percentage of the preferred bid for a corresponding performance element in the target schedule.

6. The method of claim 5, wherein the individual schedule can be public or private.

7. The method of claim 5, wherein the single vendor's bid is expressed as a percentage of the preferred bid for at least one performance element in the target schedule.

8. The method of claim 5, further comprising receiving at least one spot bid.

9. The method of claim 5, further comprising performing an auction.

10. The method of claim 8, further comprising performing an auction.

11. The method of claim 5, further comprising receiving new pricing data associated with at least one performance element in the individual schedule and adjusting the individual schedule for said at least one performance element.

12. The method of claim 5, wherein the single vendor's bid is expressed as a percentage of the preferred bid for all performance elements in the target schedule.

13. The method of claim 5, wherein the single vendor's bid is expressed as a dollar figure for at least one performance element.

14. The method of claim 1, wherein the preferred bid for different elements may come from different vendors.

15. The method of claim 1, further comprising identifying differences between at least two vendor bids on an individual performance element basis.

16. The method of claim 1, further comprising identifying differences between at least two vendor bids on a total cost basis.

17. The method of claim 1, further comprising providing a database of at least one demand set template comprising all performance elements relevant to an industry.

18. The method of claim 17, wherein the at least one template is pre-populated with data previously supplied by the buyer.

19. The method of claim 1, further comprising:
identifying a price for a job consisting of at least one performance element by associating said at least one performance element with a corresponding preferred bid.

20. The method of claim 19, further comprising:
notifying at least one vendor that said vendor is selected to perform the job;
receiving a reviewed demand set from the vendor, wherein the demand set may contain changes to at least one performance element;
identifying a new price for the job by associating each performance element in the reviewed demand set with a corresponding performance element in the schedule.

21. The method of claim 1, further comprising receiving at least one spot bid.

22. The method of claim 1, further comprising performing an auction.

23. The method of claim 21, further comprising performing an auction.

24. The method of claim 1, further comprising receiving new pricing data associated with at least one performance element and adjusting the preferred bid for said at least one performance element.

25. The method of claim 1, further comprising compiling a schedule of the preferred bid for each performance element.

26. A method of standardizing price discovery and negotiation using a computer processing system comprising:
receiving at least one demand set comprising a buyer's specifications for performance elements;
associating with said demand set a first round of at least one vendor bid;
analyzing the first round of at least one vendor bid to identify a first preferred bid for each performance element;
associating with said demand set a second round of at least one vendor bid for at least one performance element, wherein said second round of at least one vendor bid is a percentage of the first preferred bid for at least one performance element;
identifying at least one second preferred bid for each performance element; and
compiling a schedule of second preferred bids for each performance element.

27. A method of claim 26, wherein the first preferred bid consists of a group of a lowest bid, an nth lowest bid, a mean bid and a median bid.

28. A method of claim 26, wherein the second preferred bid consists of a group of a lowest bid, an nth lowest bid, a mean bid and a median bid.

29. The method of claim 26, wherein the demand set comprises specifications selected from the group of specifications for performance elements which the buyer demanded in the past, specifications for performance elements which the buyer expects to demand in the future and a combination thereof.

30. The method of claim 26, wherein the at least one vendor on the schedule is bound to provide services to the buyer according to said vendor's bids as listed on the schedule for a predetermined amount of time.

31. The method of claim 26, wherein said second round of at least one vendor bid is expressed as a percentage of first preferred bid for at least one performance element from the first round.

32. The method of claim 26, wherein said second round of at least one vendor bid is expressed as a percentage of the first preferred bid for all performance elements from the first round.

33. The method of claim 26, wherein said second round of at least one vendor bid is expressed as a dollar figure for at least one performance element.

34. The method of claim 25, wherein the first preferred bid for different elements may come from different vendors.

35. The method of claim 25, further comprising identifying a price for a job consisting of at least one performance element by associating said at least one performance element with a corresponding performance element in the schedule.

36. The method of claim 35, further comprising identifying a preferred price for said job by comparing at least two vendor bids for each corresponding element in the schedule.

37. The method of claim 35, further comprising:
notifying at least one vendor that said vendor is selected to perform the job;
receiving a reviewed demand set from the vendor, wherein the demand set may contain changes to at least one performance element;
identifying a new price for the job by associating each performance element in the reviewed demand set with a corresponding performance element in the schedule.

38. The method of claim 26, further comprising identifying differences between at least two vendors on the schedule on an individual performance element basis.

39. The method of claim 26, further comprising identifying differences between at least two vendors on the schedule on a total cost basis.

40. The method of claim 26, further comprising providing a database of at least one demand set template comprising all performance elements relevant to an industry.

41. The method of claim 40, wherein the at least one template is pre-populated with data previously supplied by the buyer.

42. The method of claim 26, further comprising receiving at least one spot bid.

43. The method of claim 26, further comprising performing an auction.

44. The method of claim 42, further comprising performing an auction.

45. The method of claim 26, further comprising receiving new pricing data associated with at least one performance element in the schedule and adjusting the schedule for said at least one performance element.

46. A system for standardizing price discovery and negotiation comprising:
a receiving device for receiving at least one demand set comprising a buyer's specifications for performance elements;
an associating means for associating with said demand set at least one vendor bid; and
a processor for analyzing the at least one vendor bid to identify an preferred bid for each performance element.

47. A system of claim 46, wherein the preferred bid consists of a group of a lowest bid, an nth lowest bid, a mean bid and a median bid.

48. A system for standardizing price discovery and negotiation comprising:
a receiving device for receiving at least one demand set comprising a buyer's specifications for performance elements;
a means for associating with said demand set a first round of at least one vendor bid;
a processor for analyzing the first round of at least one vendor bid to identify a first preferred bid for each performance element;
a means for associating with said demand set a second round of at least one vendor bid for at least one performance element, wherein said second round of at least one vendor bid is a percentage of the first preferred bid for at least one performance element;
a processor for identifying at least a second preferred bid for each performance element; and
a processor for compiling a schedule of the second preferred bids for each performance element.

49. A system of claim 48, wherein the first preferred bid consists of a group of a lowest bid, an nth lowest bid, a mean bid and a median bid.

50. A system of claim 48, wherein the second preferred bid consists of a group of a lowest bid, an nth lowest bid, a mean bid and a median bid.

51. A method of standardizing price discovery and negotiation using a computer processing system comprising:
receiving at least one demand for a generic bid;
associating with said demand at least one vendor bid; and
analyzing the at least one vendor bid to identify a preferred bid for each performance element.

52. A method of standardizing price discovery and negotiation using a computer processing system comprising:
receiving at least one demand for a generic bid;
associating with said demand a first round of at least one vendor bid;
analyzing the first round of at least one vendor bid to identify a first preferred bid;
associating with said demand a second round of at least one vendor bid, wherein said second round of at least one vendor bid is a percentage of the first preferred bid; and
identifying a second preferred bid.
